(19) United States
(12) Patent Application Publication
(10) Pub. No.: US 2025/0081243 A1
(43) Pub. Date: Mar. 6, 2025

(54) MEASUREMENT GAPS FOR RACH UNDER MULTI-SIM OPERATION

(71) Applicant: TELEFONAKTIEBOLAGET LM ERICSSON (PUBL), STOCKHOLM (SE)

(72) Inventors: Zhixun Tang, TÄBY (SE); Muhammad Ali Kazmi, RESTON, VA (US); Kazuyoshi Uesaka, KAWASAKI (JP)

(21) Appl. No.: 18/727,906

(22) PCT Filed: Jan. 9, 2023
(86) PCT No.: PCT/IB2023/050176

§ 371 Date: Jul. 10, 2024

(30) Foreign Application Priority Data
Jan. 10, 2022 (WO) PCT/CN2022/071140

(51) Int. Cl. H04W 74/0833

(52) U.S. Cl. CPC H04W 74/0833

(57) ABSTRACT

Systems and methods related to configuring measurement gaps on a first cell of a first network to enable a Random Access (RA) procedure on at least one second cell of a second network are disclosed. In one embodiment, a method performed by a User Equipment (UE) comprises determining, for a first cell of a first network, a first set of measurement gaps that the UE may use or is expected to use to perform a RA procedure in at least one second cell of a second network and transmitting information about the first set of measurement gaps to one or more network nodes. In this manner, configuration of measurement gaps to enable the RA procedure in the at least one second cell in the second network is enabled. Corresponding embodiments of a UE are also disclosed.

### RELATED APPLICATIONS

This application claims the benefit of International patent application serial number PCT/CN2022/071140, filed Jan. 10, 2022, the disclosure of which is hereby incorporated herein by reference in its entirety.

### TECHNICAL FIELD

The present disclosure relates to random access in a cellular communications system.

### BACKGROUND

### Multi-USIM Operation

A multi-Universal Subscriber Identity Module (USIM) (i.e., a MUSIM) User Equipment (UE) has two or more subscriptions for different services (e.g., use one individual subscription and one family circle plan). Each USIM or Subscriber Identity Module (SIM) may be associated with one subscription. Different USIMs or SIMs in the UE may be associated with or belong to or registered with the same operator or different operators. In one MUSIM scenario, the UE may be in Radio Resource Control (RRC) idle (i.e., RRC_IDLE) state or inactive (i.e., RRC_INACTIVE) state with respect to all the registered networks. In this case, the UE needs to monitor and receive paging from more than one network. In another MUSIM scenario, the UE may be in RRC idle state or inactive state with respect to one of the registered networks while in RRC connected state with respect to another network. In this case, the UE needs to monitor and receive paging from one network while receiving/transmitting data in another network.

### UE Operation in RRC_IDLE and RRC_INACTIVE States

In RRC_IDLE, the UE monitors the paging channels for core network-initiated paging. In RRC_INACTIVE, the UE also monitors paging channels for Radio Access Network (RAN)-initiated paging. In RRC_INACTIVE, the UE can move within an area configured by the RAN (i.e., the Next Generation RAN (NG-RAN) in the case of Third Generation Partnership Project (3GPP) New Radio (NR)) without notifying the RAN. The UE in RRC_IDLE or RRC_INACTIVE is only required to monitor paging channels during one Paging Occasion (PO) per Discontinuous Reception (DRX) cycle. This is referred to as the paging DRX cycle, which is configured by the network. The different POs in a DRX cycle are configurable via system information, and the network may distribute UEs to the POs based on their UE Identities (IDs).

In RRC_IDLE and RRC_INACTIVE, the UE can perform serving cell evaluation, cell selection, and cell reselection including detection and measurements. In RRC_IDLE or RRC_INACTIVE, the UE measures the serving cell (e.g., Synchronization Signal (SS) Reference Signal Received Power (RSRP) (i.e., SS-RSRP) and SS Reference Signal Received Quality (RSRQ) (i.e., SS-RSRQ) level of the serving cell) and, based on the serving cell measurement, evaluates the cell selection criterion S defined in 3GPP Technical Specification (TS) 38.304 v16.6.0 for the serving cell at least once every M1*N1 DRX cycle, where N1 is the scaling factor given in Table 1 and:

$$M 1 = 2 if SS based Measurement Timing Configuration ( SMTC ) periodicity ( {T}_{SMTC} ) > 20 milliseconds ( ms ) and DRX cycle \leq 0.64 second ,$$

otherwise M1=1.

The UE filters each of the serving cell measurements (e.g., SS-RSRP and SS-RSRQ measurements of the serving cell) using at least two measurements. Within the set of measurements used for the filtering, at least two measurements are spaced by at least DRX cycle/2. If the UE has evaluated, according to Table 1, that in Nserv consecutive DRX cycles the serving cell does not fulfil the cell selection criterion S defined in 3GPP TS 38.304 v16.6.0, then the UE initiates the measurements of all neighbor cells indicated by the serving cell, regardless of the measurement rules currently limiting UE measurement activities.

TABLE 1
Evaluation of serving cell during Nₛₑᵣᵥ

| | Scaling Factor (N1) | | Nₛₑᵣᵥ |
|---|---|---|---|
| DRX cycle length [s] | FR1 | FR2^{Note1} | [number of DRX cycles] |
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}Applies for UE supporting power class 2&3&4. For UE supporting power class 1 or 5, N1 = 8 for all DRX cycle length.

Another example of requirements for different NR Intra-frequency measurements (e.g., NR cell identification, SS-RSRP, SS-RSRQ, etc.) performed by the UE in RRC_IDLE and RRC_INACTIVE is shown in Table 2. The UE identifies new Intra-frequency cells and performs SS-RSRP and SS-RSRQ measurements of the identified Intra-frequency cells within T_{detect,NR_Intra}. The UE measures SS-RSRP and SS-RSRQ of the identified Intra-frequency cells at least every T_{measure,NR_Intra}. The UE evaluates an identified cell for cell reselection within T_{evaluate,NR_Intra}. SS-RSRP and SS-RSRQ of the identified Intra-frequency cells at least every T_{measure,NR_Intra}. The UE filters SS-RSRP and SS-RSRQ measurements of each measured Intra-frequency cell using at least two measurements. Within the set of measurements used for the filtering, at least two measurements are spaced by at least T_{measure,NR_Intra}/2.

The UE does not consider a NR neighbor cell in cell reselection if it is indicated as not allowed in the measurement control system information of the serving cell.

Similar requirements are specified for NR inter-frequency measurements (e.g., cell identification, SS-RSRP, SS-RSRQ, etc.) and inter-Radio Access Technology (RAT) measurements (e.g., Long Term Evolution (LTE) cell identification, LTE RSRP, LTE RSRQ, etc.) performed by the UE in RRC_IDLE and RRC_INACTIVE.

TABLE 2
Intra-frequency cell reselection requirements in NR: T_{detect, NR}_{_{—}}
_{Intra,} T_{measure, NR}_{_{—}}_{Intra} and T_{evaluate, NR}_{_{—}}_{Intra}

| DRX | | | | | |
|---|---|---|---|---|---|
| cycle | Scaling Factor | | T_{detect, NR}_{_{—}}_{Intra} [s] | T_{measure, NR}_{_{—}}_{Intra} [s] | T_{evaluate, NR}_{_{—}}_{Intra} [s] |
| length | (N1) | | (number of DRX | (number of DRX | (number of DRX |
| [s] | FR1 | FR2^{Note1} | cycles) | cycles) | cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

^{Note1}Applies for UE supporting power class 2&3&4. For UE supporting power class 1 or 5, N1 = 8 for all DRX cycle length.
Note 2:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

### Random Access Procedure in NR

In NR, the UE may be configured by the network to perform random access (RA) in a cell (e.g., serving cell or a neighbor cell) using 4-step RA procedure and/or using 2-step RA procedure. If the UE is configured with both RA types, then the UE may select and use one of the two RA procedures for RA transmission based on one or more selection criteria, e.g. based on signal strength, etc.

### 4-Step RA Type:

The principle of the 4-step RA procedure in NR is shown in FIG. 1. It involves 4 steps each comprising one message (uplink (UL) or downlink (DL)).

### Step 1: Preamble Transmission

The UE randomly selects a RA preamble (PREAMBLE_INDEX) corresponding to a selected Synchronization Signal (SS)/Physical Broadcast Channel (PBCH) block, transmit the preamble on the Physical Random Access Channel (PRACH) occasion mapped by the selected SS/PBCH block. When the base station (BS) (e.g., gNB) detects the preamble, it estimates the Timing Advance (TA) that the UE should use in order to obtain uplink (UL) synchronization at the BS (e.g., gNB). The “RA preamble transmission” by the UE is also referred to as Message #1 (Msg1).

### Step 2: RA Response (RAR)

The BS (e.g., gNB) sends a RAR including the TA, the Temporary Cell Radio Network Temporary Identifier (TC-RNTI) (temporary identifier) to be used by the UE, a Random Access Preamble identifier that matches the transmitted PREAMBLE_INDEX, and a grant for Msg3. The UE expects the RAR and thus monitors for a Physical Downlink Control Channel (PDCCH) addressed to the RA Radio Network Temporary Identifier (RA-RNTI) to receive the RAR message from the BS (e.g., gNB) until the configured RAR window (ra-ResponseWindow) has expired or until the RAR has been successfully received.

From 3GPP TS 38.321 v16.6.0: “The MAC entity may stop ra-ResponseWindow (and hence monitoring for Random Access Response(s)) after successful reception of a Random Access Response containing Random Access Preamble identifiers that matches the transmitted PREAMBLE_INDEX.” The “RA response” transmission by the BS is also referred to as Message #2 (Msg2).

### Step 3: “Msg3” (UE ID or UE-Specific Cell Radio Network Temporary Identifier (C-RNTI))

In Message #3 (Msg3), the UE transmits its identifier (UE ID) for initial access or, if it is already in RRC_CONNECTED or RRC_INACTIVE mode and needs to, e.g., re-synchronize, its UE-specific Radio Network Temporary Identifier (RNTI).

If the BS (e.g., gNB) cannot decode Msg3 at the granted UL resources, it may send a Downlink Control Information (DCI) addressed to TC-RNTI for retransmission of Msg3. Hybrid Automatic Repeat Request (HARQ) retransmission is requested until the UE restarts the random access procedure from step 1 after reaching the maximum number of HARQ retransmissions or until Msg3 can be successfully received by the BS (e.g., gNB). The “UE ID transmission” by the UE is also referred to as Message #3 (Msg3).

### Step 4: “Msg4” (Contention Resolution)

In Message #4 (Msg4), the BS (e.g., gNB) responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously. For Msg4 reception, the UE monitors TC-RNTI (if it transmitted its UE ID in Msg3) or C-RNTI (if it transmitted its C-RNTI in Msg3). The “UE ID transmission” by the BS for contention resolution is also referred to as Message #4 (Msg4).

### 2-Step RA Type:

The 2-step RA procedure gives much shorter latency than the ordinary 4-step RA procedure. In the 2-step RA procedure, the RA preamble (Msg1) and a message corresponding to Msg3 (msgA Physical Uplink Shared Channel (PUSCH)) in the 4-step RA can, depending on configuration, be transmitted in two subsequent slots. The msgA PUSCH is sent on a resource dedicated to the specific RA preamble. This means that both the preamble and the Msg3 face contention but contention resolution in this case means that either both preamble and Msg 3 are sent without collision or both collide. The 2-step RA procedure is depicted in FIG. 2.

Upon successful reception of the msgA, the gNB will respond with a msgB. The msgB may be either a “successRAR”, “fallbackRAR”, or “Back off”. The content of msgB has been agreed as seen below. It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

If both the 4-step RA and 2-step RA are configured in a cell on shared PRACH resources (and for the UE), the UE will choose its preamble from one specific set if it wants to do a 4-step RA and from another set if it wants to do a 2-step RA. Hence, a preamble partition is done to distinguish between 4-step RA and 2-step RA when shared PRACH resources are used. Alternatively, the PRACH configurations are different for the 2-step RA procedure and the 4-step RA procedure, in which case it can be deduced from where the preamble transmission is done if the UE is doing a 2-step RA or 4-step RA procedure.

In the 2-step RA procedure, UEs are informed of the potential time-frequency resources where they may transmit MsgA PRACH and MsgA PUSCH via higher layer signaling from the network. PRACH is transmitted in periodically recurring Random Access Channel (RACH) occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions which is measured from the start of a corresponding RACH occasion. Multiple PUSCH occasions may be multiplexed in time and frequency in a MsgA PUSCH configuration, where POs in an Orthogonal Frequency Division Multiplexing (OFDM) symbol occupy a given number of Physical Resource Blocks (PRBs) and are adjacent in frequency, and where POs occupy ‘L’ contiguous OFDM symbols. POs multiplexed in time in a MsgA PUSCH configuration may be separated by a configured gap that is ‘G’ symbols long. The start of the first occupied OFDM symbol in a PUSCH slot is indicated via a start and length indicator value (SLIV). The MsgA PUSCH configuration may comprise multiple contiguous PUSCH slots, each slot containing the same number of POs. The start of the first PRB relative to the first PRB in a bandwidth part (BWP) is also given by the MsgA PUSCH configuration. Moreover, the Modulation And Coding Scheme (MCS) for MsgA PUSCH is also given by the MsgA PUSCH configuration.

Each PRACH preamble maps to a PUSCH occasion and a Demodulation Reference Signal (DMRS) port and/or a DMRS port-scrambling sequence combination according to a procedure given in 3GPP TS 38.213 v17.0.0. This mapping allows a BS (e.g., gNB) to uniquely determine the location of the associated PUSCH in time and frequency as well as the DMRS port and/or scrambling from the preamble selected by the UE.

The PRACH preambles also map to associated SSBs. The SSB to preamble association combined with the preamble to PUSCH association allow a PO to be associated with a RACH preamble. This indirect preamble to PUSCH mapping may be used to allow a gNB using analog beamforming to receive a MsgA PUSCH with the same beam that it uses to receive the MsgA RACH preamble.

### RACH Occasion

In NR, since the BS (e.g., gNB) controls the UL transmission to avoid the collision among UEs, the BS (e.g., gNB) assigns dedicated UL resources in frequency and time domain. One exception is the case when a UE will make an initial access to the BS from IDLE/INACTIVE states. Random access is the procedure used when the UE initiates a connection with the BS (e.g., gNB).

In both 4-step RA type and 2-step RA type procedures, the UE transmits a random access preamble using PRACH at the beginning of random access attempts. Since the BS (e.g., gNB) does not know when the UE initiates the random access, the BS (e.g., gNB) allocates the UL resources for PRACH periodically, called RACH periodicity. RACH periodicity is configurable, e.g., 10 milliseconds (ms), 20 ms, 40 ms, 80 ms, and 160 ms.

FIG. 3 illustrates the relation between RACH occasion and paging period (or DRX cycle).

### DRX Cycle Operation

The UE can be configured with a DRX cycle to use in all RRC states (e.g., RRC idle state, RRC inactive state, and RRC connected state) to save UE power consumption and battery life. Examples of lengths of DRX cycles currently used in RRC idle/inactive state are 256 ms, 320 ms, 640 ms, 1.28 seconds (s), 2.56 s, 5.12 s, 10.24 s, etc. Examples of lengths of DRX cycles currently used in RRC connected state may range from 256 ms to 10.24 s. The DRX cycle is configured by the network node and is characterized by the following parameters:
On duration: During the on duration of the DRX cycle, a timer called ‘onDurationTimer’, which is configured by the network node, is running. This timer specifies the number of consecutive control channel subframes (e.g., PDCCH slots) at the beginning of a DRX Cycle. It is also interchangeably called as DRX ON period. It is the duration (e.g., in number of downlink subframes) during which the UE after waking up from DRX may receive control channel (e.g., PDCCH, wake up signal etc.). If the UE successfully decodes the control channel (e.g., PDCCH) during the on duration then the UE starts a drx-inactivity timer (see below) and stays awake until its expiry.
drx-inactivity timer: It specifies the number of consecutive control channel (e.g., PDCCH,) subframe(s) after the subframe in which a control channel (e.g., PDCCH) indicates an initial UL or downlink (DL) user data transmission for this MAC entity. It is also configured by the network node.
DRX active time: This time is the duration during which the UE monitors the control channel (e.g., PDCCH, wake up signals etc.). In other words, this is the total duration during which the UE is awake. This includes the “on-duration” of the DRX cycle, the time during which the UE is performing continuous reception while the inactivity timer has not expired and the time the UE is performing continuous reception while waiting for a DL retransmission after one HARQ round trip time. This means duration over which the drx-inactivity timer is running is called as DRX active time, i.e. no DRX is used by the UE.
DRX inactive time: The time during the DRX cycle other than the active time is called as DRX inactive time, i.e. DRX is used by the UE.

The DRX active time and DRX inactive time are also called as DRX ON and DRX OFF durations of the DRX cycle respectively are shown in FIG. 4. The DRX inactive time may also be called as non-DRX or non-DRX period. The DRX operation with more detailed parameters is illustrated in FIG. 5.

DRX configuration herein may also be an enhanced or extended DRX (eDRX) configuration which applies in RRC_IDLE or RRC_INACTIVE states (only up to 10.24 seconds). In legacy DRX related procedures the UE can be configured with DRX cycle length of up to 10.24 seconds. But UEs supporting extended DRX (eDRX) can be configured with a DRX cycle at least longer than 10.24 seconds and typically much longer than 10.24 seconds, i.e. in order of several seconds to several minutes, e.g. 176 minutes. The eDRX configuration parameters include an eDRX cycle length, paging window length aka paging time window (PTW) length, etc. Within a PTW of the eDRX, the UE is further configured with one or more legacy DRX cycles.

### Measurement Gaps

A Measurement Gap Pattern (MGP) is used by the UE for performing measurements on cells of the non-serving carriers (e.g., inter-frequency carrier, inter-Radio Access Technology (RAT) carriers, etc.). In NR, measurement gaps are also used for measurements on cells of the serving carrier in some scenarios, e.g. if the measured signals (e.g., SSB) are outside the bandwidth part (BWP) of the serving cell. The UE is scheduled in the serving cell only within the BWP. During a measurement gap, the UE cannot be scheduled for receiving/transmitting signals in the serving cell. A measurement gap pattern is characterized or defined by several parameters: measurement gap length (MGL), measurement gap repetition period (MGRP), measurement gap time offset (MGTO) with respect to reference time (e.g., slot offset with respect to the serving cell's system frame number (SFN) such as SFN=0), measurement gap timing advance (MGTA), etc. An example of a MGP is shown in FIG. 6. As an example, the MGL can be 1.5, 3, 3.5, 4, 5.5, or 6 ms, and the MGRP can be 20, 40, 80, or 160 ms. Such type of MGP is configured by the network node and is also referred to as a network controlled or network configurable MGP. Therefore, the serving base station is fully aware of the timing of each measurement gap within the MGP.

In NR there are two major categories of MGPs: per-UE measurement gap patterns and per-FR measurement gap patterns. In NR, the spectrum is divided into two frequency ranges namely FR1 and FR2. FR1 is currently defined from 410 Megahertz (MHz) to 7125 MHz. FR2 range is currently defined from 24250 MHz to 52600 MHz. In another example, the FR2 range can be from 24250 MHz to 71000 MHz, where the frequency range 24250-52600 MHz is called FR2-1 and frequency range 52600-71000 MHz is called FR2-2. The FR2 range is also interchangeably referred to as millimeter wave (mmwave) and corresponding bands in FR2 are referred to as mmwave bands. In the future, more frequency ranges can be specified, e.g. FR3. An example of FR3 is frequency ranging between 7125 MHz and 24250 MHz.

When configured with a per-UE MGP, the UE creates gaps on all the serving cells (e.g., Primary Cell (PCell), Primary Secondary Cell (PSCell), Secondary Cells (SCells), etc.) regardless of their frequency range. The per-UE MGP can be used by the UE for performing measurements on cells of any carrier frequency belonging to any RAT (e.g., 5G NR, 4G LTE/LTE-advanced, 3G WCDMA/HSPA/CDMA2000, 2G GSM) or frequency range (FR). When configured with a per-FR MGP (if UE supports this capability), the UE creates gaps only on the serving cells of the indicated FR whose carriers are to be measured. For example, if the UE is configured with a per-FR1 MGP, then the UE creates measurement gaps only on serving cells (e.g., PCell, PSCell, SCells, etc.) of FR1 while no measurement gaps are created on serving cells on carriers of FR2. The per-FR1 measurement gaps can be used for measurements on cells of only FR1 carriers. Similarly, per-FR2 measurement gaps when configured are only created on FR2 serving cells and can be used for measurements on cells of only FR2 carriers. Support for per FR gaps is a UE capability, i.e. certain UEs may only support per UE gaps according to their capability.

In NR Rel-17, Concurrent Measurement Gap Pattern (C-MGP) or interchangeably referred to as concurrent gaps or concurrent measurement gaps are being specified. A C-MGP comprises multiple measurement gap patterns (e.g., two or more MGPs) which can be configured by the network node using the same or different messages (e.g., same or different RRC messages).

### SUMMARY

Systems and methods related to configuring measurement gaps on a first cell of a first network to enable a Random Access (RA) procedure on at least one second cell of a second network are disclosed. In one embodiment, a method performed by a User Equipment (UE) comprises determining, for a first cell of a first network, a first set of measurement gaps that the UE may use or is expected to use to perform a RA procedure in at least one second cell of a second network and transmitting information about the first set of measurement gaps to one or more network nodes. In this manner, configuration of measurement gaps to enable the RA procedure in the at least one second cell in the second network is enabled. Corresponding embodiments of a UE are also disclosed.

In one embodiment, a method performed by a first network node that manages or controls or serves a first cell of a first network comprises receiving, from a UE, information about a first set of measurement gaps for the UE for the first cell of the first network, the first set of measurement gaps being a set of measurement gaps that the UE may use or is expected to use to perform a RA procedure in at least one second cell of a second network. The method further comprises performing one or more operational tasks based on the information about the first set of measurement gaps. Corresponding embodiments of a first network node are also disclosed.

In one embodiment, a method performed by a second network node for a second network comprises receiving, from a UE, a request to reconfigure one or more RA related parameters for performing a RA procedure in at least one cell of the second network and performing one or more operational tasks responsive to the request. Corresponding embodiments of a second network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a 4-step Random Access (RA) procedure;

FIG. 2 illustrates a 2-step RA procedure;

FIG. 3 illustrates an example of downlink (DL)/uplink (UL) resources for a User Equipment (UE) in IDLE/INACTIVE mode;

FIG. 4 illustrate a Discontinuous Reception (DRX) cycle showing ON and OFF durations;

FIG. 5 illustrates a DRX cycle showing different DRX related parameters;

FIG. 6 illustrates an example of a measurement gap pattern in Third Generation Partnership Project (3GPP) New Radio (NR);

FIG. 7 illustrate an example of a cellular communication system in which embodiments of the present disclosure may be implemented;

FIG. 8 is a flow chart that illustrates the operation of UE in accordance with embodiments of the present disclosure;

FIG. 9 illustrates a general example of time location of N different messages involved in RA procedure;

FIG. 10 illustrates an example of two different sets of measurement gaps (MGS1 and MGS2) for performing 4-step RA procedure based on relative time location of messages involved in 4-step RA procedure;

FIG. 11 illustrates an example of two different sets of measurement gaps (MGS1 and MGS2) for performing 2-step RA procedure based on relative time location of messages involved in 2-step RA procedure;

FIG. 12 is a flow chart that illustrates the operation of a first network node in a first network in accordance with embodiments of the present disclosure;

FIG. 13 is a flow chart that illustrates the operation of a second network node in a second network in accordance with embodiments of the present disclosure;

FIG. 14 illustrates one example of the operation of a UE, a first network node, and a second network node, in accordance with embodiments of the present disclosure;

FIG. 15 is a schematic block diagram of a network node according to some embodiments of the present disclosure;

FIG. 16 is a schematic block diagram that illustrates a virtualized embodiment of the network node of FIG. 15 according to some embodiments of the present disclosure;

FIG. 17 is a schematic block diagram of the network node of FIG. 15 according to some other embodiments of the present disclosure;

FIG. 18 is a schematic block diagram of a User Equipment device (UE) according to some embodiments of the present disclosure;

FIG. 19 is a schematic block diagram of the UE of FIG. 18 according to some other embodiments of the present disclosure;

FIG. 20 illustrates a telecommunication network connected via an intermediate network to a host computer in accordance with some embodiments of the present disclosure;

FIG. 21 is a generalized block diagram of a host computer communicating via a base station with a UE over a partially wireless connection in accordance with some embodiments of the present disclosure;

FIG. 22 is a flowchart illustrating a method implemented in a communication system in accordance with one embodiment of the present disclosure;

FIG. 23 is a flowchart illustrating a method implemented in a communication system in accordance with one embodiment of the present disclosure;

FIG. 24 is a flowchart illustrating a method implemented in a communication system in accordance with one embodiment of the present disclosure; and

FIG. 25 is a flowchart illustrating a method implemented in a communication system in accordance with one embodiment of the present disclosure.

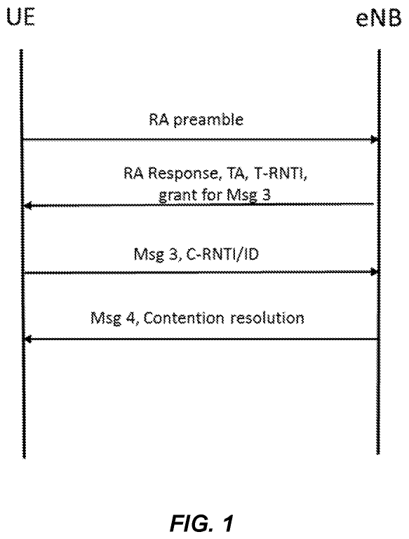

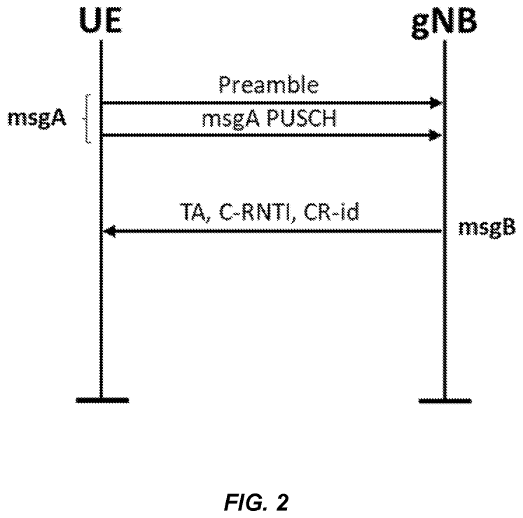

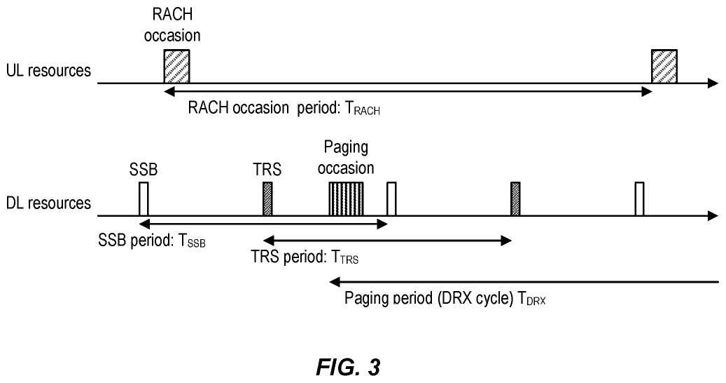

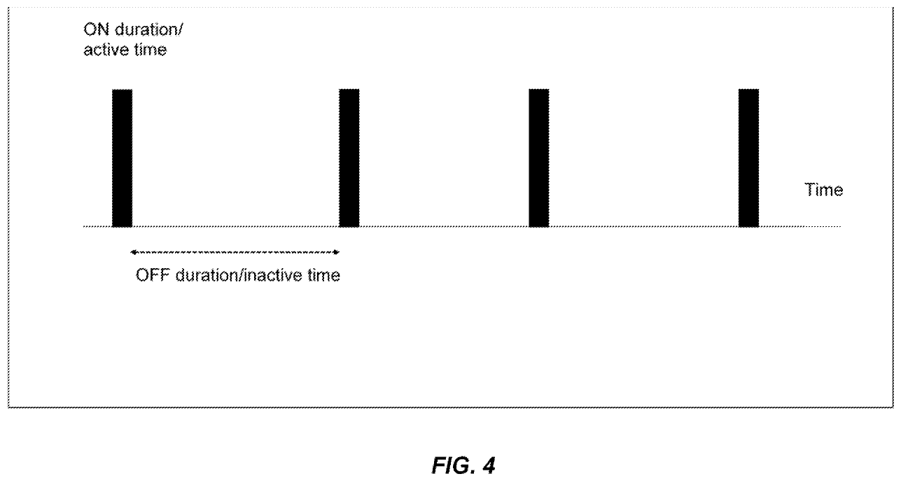

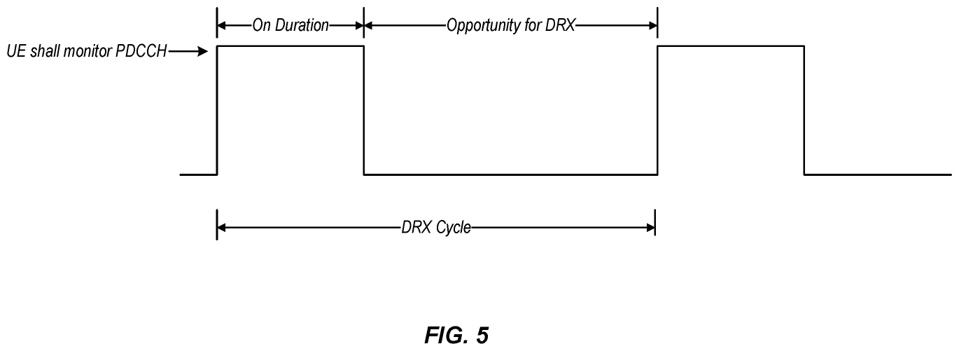

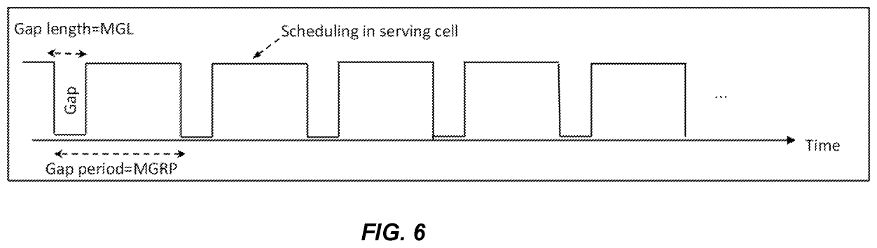

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

### 1 Terminology

In the present disclosure, the term “node” is used to generally refer to either a network node or a User Equipment (UE).

Examples of network nodes are NodeB, Base Station (BS), Multi-Standard Radio (MSR) radio node such as MSR BS, eNodeB (eNB), gNodeB (gNB), Master eNB (MeNB), Secondary eNB (SeNB), Location Measurement Unit (LMU), Integrated Access Backhaul (IAB) node, network controller, Radio Network Controller (RNC), Base Station Controller (BSC), relay, donor node controlling relay, Base Transceiver Station (BTS), Central Unit (e.g. in a gNB), Distributed Unit (e.g. in a gNB), Baseband Unit, Centralized Baseband, Cloud RAN (C-RAN), Access Point (AP), transmission points, transmission nodes, Transmission Reception Point (TRP), Remote Radio Unit (RRU), Remote Radio Head (RRH), nodes in Distributed Antenna System (DAS), core network node (e.g. Mobile Switching Center (MSC), Mobility Management Entity (MME), Access and Mobility Management Function (AMF), etc.), Operations and Management (O&M), Operations and Support System (OSS), Self-Organizing Network (SON), positioning node (e.g. Evolved Serving Mobile Location Center (E-SMLC)), etc.

The non-limiting term “user equipment” or “UE” refers to any type of wireless device communicating with a network node and/or with another UE in a cellular or mobile communication system. Examples of a UE are target device, Device to Device (D2D) UE, Vehicular to Vehicular (V2V), machine type UE, Machine Type Communication (MTC) UE or UE capable of Machine to Machine (M2M) communication, Personal Digital Assistant (PDA), tablet, mobile terminals, smart phone, Laptop Embedded Equipment (LEE), Laptop Mounted Equipment (LME), Universal Serial Bus (USB) dongle, etc.

The term “radio access technology”, or “RAT”, may refer to any RAT, e.g. Universal Terrestrial Radio Access (UTRA), Evolved UTRA (E-UTRA), narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term “signα1” or “radio signα1” used herein can be any physical signal or physical channel. Examples of downlink (DL) physical signals are reference signal (RS) such as Primary Synchronization Signal (PSS), Secondary Synchronization Signal (SSS), Channel State Information (CSI) Reference Signal (CSI-RS), Demodulation Reference Signal (DMRS) signals in Synchronization Signal (SS)/Physical Broadcast Channel (PBCH) block (SSB), Discovery Reference Signal (DRS), Cell-specific Reference Signal (CRS), Positioning Reference Signal (PRS), etc. RS may be periodic, e.g. RS occasion carrying one or more RSs may occur with certain periodicity, e.g. 20 ms, 40 ms, etc. The RS may also be aperiodic. Each SSB carries NR PSS (NR-PSS), NR SSS (NR-SSS), and NR Physical Broadcast Channel (NR-PBCH) in four successive symbols. One or multiple SSBs are transmit in one SSB burst which is repeated with certain periodicity, e.g. 5 ms, 10 ms, 20 ms, 40 ms, 80 ms, and 160 ms. The UE is configured with information about SSB on cells of certain carrier frequency by one or more SS/PBCH block Measurement Timing Configuration (SMTC) configurations. The SMTC configuration comprises parameters such as SMTC periodicity, SMTC occasion length in time or duration, SMTC time offset with respect to a reference time (e.g., serving cell's System Frame Number (SFN)), etc. Therefore, SMTC occasion may also occur with certain periodicity, e.g. 5 ms, 10 ms, 20 ms, 40 ms, 80 ms, and 160 ms. Examples of uplink (UL) physical signals are reference signal such as Sounding Reference Signal (SRS), Demodulation Reference Signal (DMRS), etc. The term “physical channel” refers to any channel carrying higher layer information, e.g. data, control etc. Examples of physical channels are PBCH, Narrowband PBCH (NPBCH), Physical Downlink Control Channel (PDCCH), Physical Downlink Shared Channel (PDSCH), Physical Uplink Control Channel (PUCCH), Physical Uplink Shared Channel (PDSCH), short PUCCH (sPUCCH), short PDSCH (sPDSCH), Short PUCCH (sPUCCH), Short PUSCH (sPUSCH), MTC PDCCH (MPDCCH), Narrowband PDCCH (NPDCCH), Narrowband PDSCH (NPDSCH), Enhanced PDCCH (E-PDCCH), Narrowband PUSCH (NPUSCH), etc.

The term “time resource” used herein may correspond to any type of physical resource or radio resource expressed in terms of length of time. Examples of time resources are: symbol, sub-slot, mini-slot, slot or time slot, subframe, radio frame, Transmission Time Interval (TTI), interleaving time, SFN cycle, hyper-SFN cycle, etc.

The term “multi-USIM” used herein may also be called as multi-subscription, multi-SIM, dual SIM, dual-USIM, etc. The term “Universal Subscriber Identity Module” or “USIM” may also be simply called as Subscriber Identity Module (SIM). For consistency, multi-USIM term may be used hereinafter. Each USIM (or SIM) in the UE may be associated with at least subscription of a mobile network operator (MNO).

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

### 2 Problems with Existing Solutions

There exist certain challenges. In the multi-USIM scenario, the UE capable of multi-USIM is served by at least two serving cells which belong to different networks. The UE configured to perform a Random Access (RA) procedure in one or more cells of one of the networks (e.g., in NW2) requires gaps for operating RA messages, i.e. gaps are created on serving cell(s) in the other network (e.g., NW1). The RA procedure involves several messages (e.g., four messages in 4-step RA). In the legacy solution, one gap per RA message is used. Each gap involves additional overhead, e.g. Radio Frequency (RF) switching time. For example, a gap with MGL=6 ms comprises about 1 ms in RF switching time. Therefore, one gap per RA message is not efficient. Furthermore, the RA procedure may be used quite often and therefore the resulting larger number of gaps will lead to loss of data in the serving cell of the other network, e.g. NW1. Therefore, a new and efficient mechanism for configuring gaps for the RA procedure in multi-SIM scenario is needed.

### 3 Overview of at Least Some Aspects of the Present Disclosure

Systems and methods that address the aforementioned and/or other challenges are described herein. The scenario comprises a UE which is configured to operate in multi-USIM scenario where: the UE's first serving cell (cell1) and a first network node (NN1) managing or serving cell1 are comprised in a first network (NW1); and the UE's second serving cell (cell2) and a second network node (NN2) managing or serving cell2 are comprised in a second network (NW2). The UE is further configured to perform a RA procedure in cell2 or to another cell, i.e., a third cell (cell3) in NW2.

Embodiments of methods in a UE, in a first network node (NN1), and a second network node (NN2) are disclosed herein. Some exemplary embodiments are as follows:
In a first embodiment, the UE determines, based one or more criteria or rules, a set of measurement gaps that the UE may use or is expected to use for performing a RA procedure in a cell (e.g., cell2 or cell3) comprised in a second network (NW2), and transmits information about the determined set of measurement gaps to a first network node (NN1) comprised in a first network (NW1). Examples of the criteria are timing of RA messages, time gap between any two RA messages, duration of the RA procedure, etc.
In a second embodiment, NN1 receives, from the UE, information about a set of measurement gaps that the UE may use or is expected to use for performing a RA procedure in a cell (e.g., cell2 or cell3) comprised in NW2, and decides whether to configure the UE with the requested set of measurement gaps. In one example, NN1 configures the UE with the set of measurement gaps as requested by the UE. In another example, NN1 may reject the UE's request or it may configure the UE with a set of measurement gaps that is different than or modified version of the requested set of measurement gaps.
In a third embodiment, NN2 receives a request from the UE to modify or reconfigure one or more parameters related to a RA procedure in a cell (e.g., cell2 or cell3) in NW2 for enabling the UE to select a suitable set of measurement gaps for performing the RA procedure in the cell in NW2, and decides whether to modify or reconfigure one or more parameters related to RA procedure in the cell as requested by the UE. In one example, NN3 may reconfigure the RA parameter(s) as requested by the UE. In another example, NN2 may reject the UE's request or it may reconfigure the RA parameter(s) such that the reconfigured RA parameter(s) is(are) different than or a modified version of the UE requested parameters.

Examples of one or more rules or criteria for determining the set of measurement gaps are: time between any two successive RA messages, total duration of RA procedure, etc. The rules and/or one or more associated parameters may be pre-defined or configured by a network node, e.g. NN1, NN2, etc.

In one embodiment, in multi-USIM operational scenario, a UE determines a number of gaps required for performing a RA procedure in one network (e.g., NW2) based on timing of different messages involved in the RA procedure and sends a request for configuring the determined gaps to a network node in another network, e.g. NW1. For example, the UE determines fewer gaps if the RA messages are close in time compared to the case when the RA messages are relatively far apart in time.

While not being limited to or by any particular advantage, embodiments of the systems and methods described herein may provide a number of advantages. For example, these advantages may include one or more of the following:
The behavior during a RA procedure in multi-USIM operational scenario is well-defined.
The mechanism ensures optimal number of gaps are used by the UE during the RA procedure in multi-USIM operational scenario.
The mechanism prevents or minimizes the loss of signal reception/transmission (e.g., data) in serving cell of the network different than the network where gaps are used for the RA procedure in multi-USIM operational scenario.
The overall performance of the RA procedure in multi-USIM operational scenario is enhanced.

### 4 Scenario Description

The scenario comprises a UE served by at least two cells: a first cell (cell1) and a second cell (cell2). Cell1 and cell2 may operate on or belong to or configured using: a first carrier frequency (F1) and a second carrier frequency (F2) respectively. The carrier frequency is also called as component carrier (CC), frequency layer, serving carrier, frequency channel etc. The carrier frequency related information is signaled to the UE using a channel number, e.g. Absolute Radio Frequency Channel Number (ARFCN), NR ARFCN (NR-ARFCN), etc. F1 and F2 may belong to the same or different frequency bands. The coverage areas of cell1 and cell2 may fully overlap or may not overlap at all or may partially with respect to each other.

Cell1 in turn is served or managed or controlled by a first network node (NN1) which is comprised in a first network (NW1). Cell2 in turned is served or managed or controlled by a second network node (NN2) which is comprised in a second network (NW2). Therefore, the UE is served by or managed by the at least two networks (NW1 and NW2). In one example, NW1 and NW2 may be managed by or belong to the same operator. In another example, NW1 and NW2 may be managed by or belong to different operators. This is realized by the UE capable of multi-USIM operation, i.e. supporting at least 2 USIMs. For example, one of the supported USIM is associated with subscription to NW1, while the other supported USIM is associated with subscription to NW2. In one scenario the UE is served by one serving cell in each NW, e.g. by cell1 and cell2 in NW1 and NW2 respectively. In another exemplary scenario the UE may further be served by more than one cell in NW1 and/or by more than one cell in NW2.

Examples of cells are serving cell, neighbor cell, non-serving cell etc. In multicarrier (MC) operation the UE is served by more than one serving cells. Each cell may operate or belong to a carrier frequency.

Examples of multi-carrier (MC) operations are carrier aggregation (CA), dual connectivity (DC), multi-connectivity (MuC), etc. The carrier frequency is also called as component carrier (CC), frequency layer, serving carrier, frequency channel etc. Examples of serving cells are special serving cell or special cell (SpCell), secondary serving cell or secondary cell (SCell), etc. SpCell may be more important than SCell as it may carry some control signaling. Examples of SpCell are primary serving cell or primary cell (PCell), primary secondary serving cell or primary secondary cell (PSCell), etc. The carrier frequencies of SpCell, SCell, PCell and PSCell are called as special CC (SpCC) or simply SpC, secondary CC (SCC), primary CC (PCC) and primary secondary CC (PSCC) or simply PSC respectively. In CA the UE has one PCell and one or more SCells. DC comprising a master cell group (MCG) which contains at least a PCell and a secondary cell group (SCG). Each of MCG and SCG may further contain one or more SCells. The PCell manages (e.g., configures, changes, release etc.) all SCells in MCG and PSCell in SCG. PSCell manages all SCells in SCG. The cells in MCG and SCG may belong to the same RAT (e.g., all cells are NR in both MCG and SCG like in NR-DC) or they may belong to different RATs (e.g., LTE cells in MCG and NR cells in SCG like in EN-DC or NR cells in MCG and LTE cells in SCG like in NE-DC).

Even though the embodiments are described assuming that the UE is served by one cell in NN1 and one cell in NN2; but they are applicable for any number of cells serving the UE in any network. In one example cell1 and cell2 are sPCell1 and sPCell2 respectively.

NN1 and NN2 may be two different logical network nodes as well as two different physical network nodes. In another example NN1 and NN2 may be two different logical network nodes but may be comprised in the same physical network node. NN1 and NN2 may or may not be physically located at the same site.

The UE may be served by cell1 and cell2 during at least partially overlapping time period. In one example, the UE is served by cell1 during time period D1 and by cell2 during time period D2. In one example D1 and D2 may fully overlap in time, e.g. D1 starts at the same time instance and also end at the same time instance. In another example D1 and D2 may only partially overlap in times, e.g. D1 and D2 may start at the same time but end at different time instances, or D1 and D2may start at different time instances but end at the same time instance, or D1 and D2 may start at different time instances and also end at different time instances.

In one example the UE may be configured to operate in the same RRC activity state with regard to cell1 and cell2 during at least partially overlapping time. In another example the UE may be configured to operate in different RRC activity states with regard to cell1 and cell2 during at least partially overlapping time. Examples of RRC activity states are low activity RRC state, high activity state, etc. In low activity RRC state the UE may typically be configured to operate using a DRX cycle which is equal to or larger than certain threshold, e.g. 320 ms or longer. In high activity RRC state the UE may or may not be configured to operate with a DRX cycle, or may be configured with any DRX cycle when configured. Examples of low activity RRC state are RRC idle state, RRC inactive state, etc. An examples of high activity RRC state is RRC connected state etc.

In some embodiments we consider a scenario where the UE is served by cell1 in NN1 in high activity RRC state (e.g., RRC connected state) but is served by cell2 in NN2 any of the low activity state and high activity RRC state. In some embodiments we consider a scenario where the UE is served by cell1 in NN1 in high activity RRC state but is served by cell2 in NN2 in any the low activity state (e.g., RRC idle state or RRC inactive state).

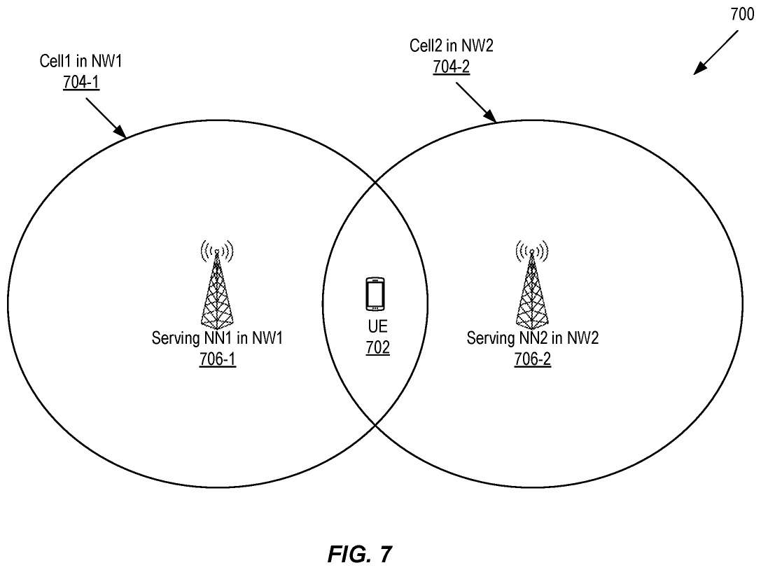

FIG. 7 illustrates an example of a cellular communications system 700 in which multi-USIM operation of a UE 702 is provided in accordance with an embodiment of the present disclosure. The UE 702 is a MUSIM UE. The UE 702 is served at a first cell 704-1 (i.e., cell1) that is managed or served or controlled by a first network node 706-1 (i.e., NN1) in a first network (i.e., NW1) and served at a second cell 704-2 (i.e., cell2) that is managed or served or controlled by a second network node 706-2 (i.e., NN2) in a second network (i.e., NW2). The scenario described in this section and illustrated in FIG. 7 is applicable to all the embodiments described herein.

### 5 Method in a UE for Determining a Set of Gaps for RA Procedure and Transmitting Information to a Network Node

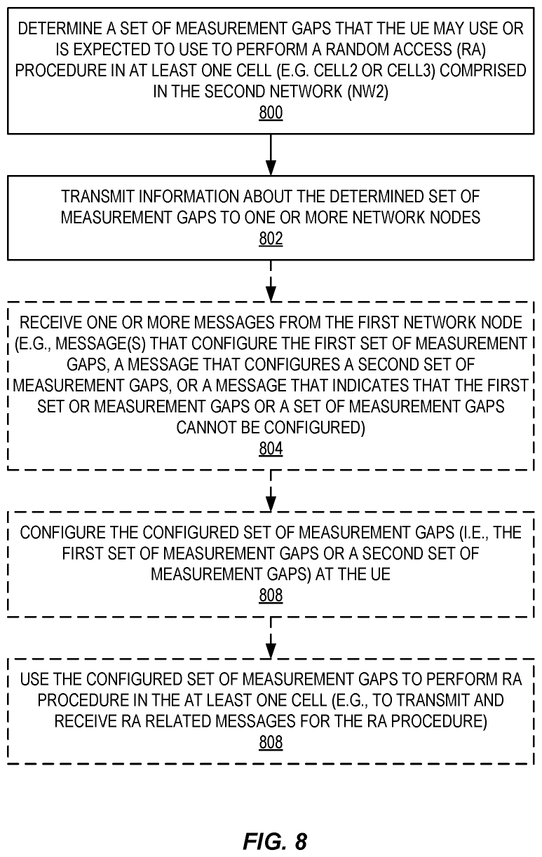

As illustrated in FIG. 8, in a first embodiment, the UE 702 performs the following procedure. Note that optional steps are represented in FIG. 8 by dashed lines/boxes. The UE 702 determines, based one or more criteria or rules, a set of measurement gaps that the UE 702 may use or is expected to use for performing a RA procedure in at least one cell (e.g., cell2 or cell3) comprised in the second network (NW2) (step 800). The UE 702 transmits information about the determined set of measurement gaps to one or more network nodes (e.g., to NN1 comprised in the first network (NW1), NN2 comprised in the second network (NW2), etc.) (step 802).

In response, the UE 702 may further receive one or more messages from NN1, e.g. via Radio Resource Control (RRC), Medium Access Control (MAC) Control Element (CE), or Downlink Control Information (DCI) command (step 804). Examples of the received message are:
A message configuring the UE 702 with the requested set of the measurement gaps
A message configuring the UE 702 with a set of measurement gaps that is different than the set of the measurement gaps requested by the UE 702. For example, the configured set of gaps may be similar to the ones requested by the UE 702.
A message informing the UE 702 that the set of the measurement gaps requested by the UE 702 cannot be configured.
A message informing the UE 702 that none of the gaps (e.g., neither the requested gaps nor any similar gaps) can be configured.

Upon receiving the message in step 804, the UE 702 configures the set of the measurement gaps (if they are provided by NN1) (step 806) and uses the configured set of the measurement gaps for performing a RA procedure in the cell (cell2 or cell3) within NW2 (step 808). Using the measurement gaps may comprise operating messages related to RA procedure during their respective gaps within the set of the configured gaps. Operating a message may comprise transmitting a message (e.g., RA preamble transmission) or receiving a message (e.g., RAR message from the NN2).

The above steps and related rules for determining set of gaps are described below with examples.

### 5.1 Determination of Set of Measurement Gaps Based on Rules

In one example, in step 800, the UE 702 determines the set of measurement gaps, i.e., the measurement gap set (MGS), based on one or more rules or criteria. In another example, the UE 702 determines or selects one set of measurement gaps among or out of at least two sets of measurement gaps: a first set of measurement gaps (MGS1) and a second set of measurement gaps (MGS2). Each MGS comprises of at least one measurement gap. The MGS may further be characterized or defined by one or more parameters related to the one or more measurement gaps and/or their relation with respect to each other in the MGS, e.g. duration of measurement gap (e.g., measurement gap length (MGL)), time or separation in time between two gaps (e.g., successive gaps), etc.

MGS1 and MGS2 differ in terms of at least the number of measurement gaps. In some embodiments MGS1 and MGS2 may also differ in terms of the MGL of at least one gap in each set. In one example, the number of measurement gaps (N11) in MGS1 is smaller than the number of measurement gaps (N12) in MGS2, i.e. N11<N12. In one specific example, N11=1 and N12>1, e.g. N12=2.

Each measurement gap in the MGS may be used for operating RA messages in a group of RA messages, which is referred to herein as a RA Message Group (RMG). The RMG may comprise one or more RA messages. The maximum size of RMG is equal to the total number of RA messages involved in the RA procedure.

The two or more MGS (m sets, e.g. MGS1, MGS2, . . . , MGSm) can be pre-defined, autonomously determined by the UE 702, or configured by a network node (e.g., NN1, NN2, etc.), e.g., via signaling (e.g., RRC, DCI, MAC-CE, etc.). The embodiments are applicable for the selection of the set of measurement gaps out of any number of sets of measurement gaps.

The UE 702 may be triggered to determine a set of measurement gaps when the UE 702 is going to or expected to perform RA procedure in a cell for one or more reasons e.g.
The UE 702 needs to perform a RA procedure in a cell to establish or setup or resume connection
The UE 702 needs to perform a RA procedure in a cell to transmit small amount of data
The UE 702 needs to perform a RA procedure in a cell to acquire synchronization, e.g. acquire new timing advance command, etc.
The UE 702 needs to perform a RA procedure in a target cell (e.g., cell3) to perform cell change, e.g. from cell2 to cell3 in NW2. Examples of cell change procedures are cell reselection, handover, RRC connection re-establishment, RRC release with redirection.

The UE 702 may obtain the timing of different RA messages within the RA procedure based on one or more of the following mechanisms:
By acquiring one or more parameters related to RA procedures in one or more messages from a network node. For example, the parameters may be transmitted in a system information (e.g., in System Information Block (SIB) such as SIB1) of a cell in NW2. The UE 702 receives the parameters by reading the system information (SI) of that cell. In another example, the parameters may be transmitted to the UE 702 in a dedicated message, e.g. cell change message such as in handover (HO) command, RRC connection release message, etc.
By acquiring one or more parameters based on pre-defined information (e.g., defined in specification) or pre-configured in the UE 702 (e.g., in the SIM or USIM card etc.).
By acquiring one or more parameters based on historical data, e.g. statistics, previously or recently used parameters, etc.

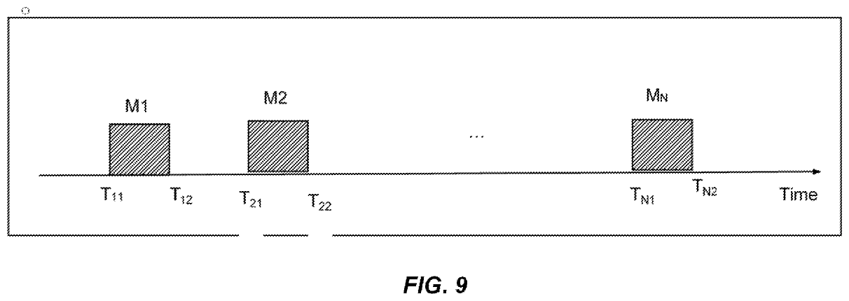

The determination of the set of measurement gaps (MGS) in step 800 is, in one embodiment, based on one or more rules or criteria, which can be pre-defined or configured by a network node, e.g. NN1, NN2, etc. Examples of rules are:
1. In a general example of a rule, the UE 702 determines the MGS based on timing of or timing related information associated with RA messages involved in or associated with the RA procedure. Examples of timing related information are total duration of the RA procedure, time gap between any two RA messages, number of RA messages occurring during certain time period, etc. The timing related criteria are further described below with more specific examples.
2. In another example of the rule, the UE 702 selects or chooses or determines the MGS based on a relation between total duration (T_{RA}) of the RA procedure and threshold (H1). The UE 702 can or is expected to operate all the RA messages, e.g. all four messages in 4-step RA, all three messages in 2-step RA, etc. In one example, if (T_{RA}<H1), then the UE 702 selects MGS1; otherwise, the UE 702 selects MGS2. H1 may further depend on the type of RA procedure, e.g. H11 and H12 for 4-step RA and 2-step RA procedures, respectively. H1, H11, and H12 may be pre-defined or configured by a network node. H1, H11, and H12 may include time to account for RF switching, implementation margin, etc. The maximum number of gaps in each MGS and/or the maximum MGL of each gap in each MGS may be pre-defined or configured by the network. Based on these parameters, the UE 702 may further determine the appropriate MGS. For example, the RA messages which are closest to each other in time may be contained within the same measurement gap. The number of messages within the same gap further depends on the max MGL of the gap. The selected MGS may also depend on the type of RA procedure. In one example, assuming N number of RA messages in the same RA procedure as shown in FIG. 9, T_{RA} may be defined as follows, e.g. N=4 for 4-step RA:

$${T}_{R A} = ( {T}_{N 2} - {T}_{11} ) \qquad ( 1 )$$

where, as shown in FIG. 9:
   T₁₁ is the starting time of the first RA message (M1) or the start of the time resource containing M1
   T_{N2} is the starting time of the last RA message (M_{N}) or the start of the time resource containing M_{N}
3. In another example of the rule, the UE 702 selects or chooses or determines the MGS based on a relation between relative time location (or time gap) between any pair of the RA messages and threshold (H2). H2 may further depend on RA type, e.g. H21 and H22 for 2-step RA and 4-step RA, respectively. H2, H21, and H22 may be pre-defined or configured by a network node. H2, H21, and H22 may also include time to account for RF switching, implementation margin, etc. The time gap (ΔT) (or relative time location or relative timings) between any two RA messages can be determined by a relation between the time locations of any two RA messages. The time location (or may simply be called timing) of each RA message can be determined by one or more of:
   Starting time of a message
   Duration of a message
   Ending time of a message
As an example:
   Tᵢ₁=Time instance at which or the start of the time resource in which the RA message I starts.
   Tᵢ₂=Time instance at which or the end of the time resource in which the RA message i ends (or completed).
   δᵢ=Duration of RA message i, can be expressed as follows:

$${δ}_{I} = ( {T}_{i 2 -} {T}_{i 1} ) \qquad ( 2 )$$

In one general example, the time gap (ΔTᵢⱼ) between any two RA messages, RA message i and RA message j, can be expressed by (2):

$$Δ {T}_{i j} = ( {T}_{i k} - {T}_{jl} ) \qquad ( 3 )$$

where:
   A general parameter representing time location of RA message i can be denoted by Tᵢₖ; where k={1,2}.
   A general parameter representing time location of RA message j can be denoted by Tⱼ₁; where 1={1,2}.

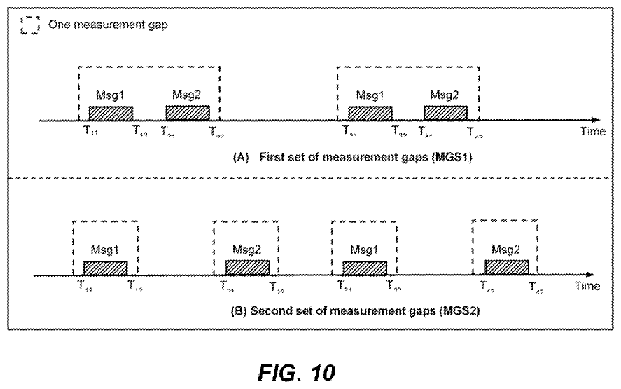

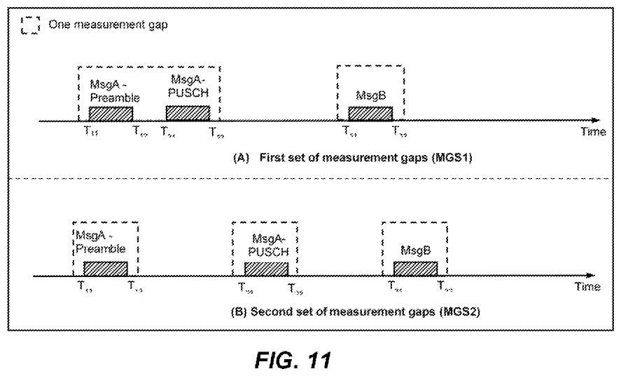

In one example, if (|ΔTᵢⱼ|<H2), then the UE 702 selects the same gap for group of RA messages (RMGij) (i.e., RA messages occurring between messages i and j, and including RA messages i and j); otherwise, the UE 702 selects two or more gaps for the same set of RA messages, i.e. in RMGij. The maximum number of gaps in each MGS and/or the maximum MGL of each gap in each MGS may be pre-defined or configured by the network. Based on this principle, the UE 702 may further determine the appropriate number of gaps in the MGS for all the RA messages in the RA procedure. The grouping of RA messages for determining whether one or more gaps are needed can be pre-defined or configured by the network node or autonomously determined by the UE 702. In one example, the UE 702 may group two or more successive RA messages and check whether they occur within the threshold, H2, or not, and accordingly determine the number of gaps.
4. In another example of the rule, the UE 702 selects or chooses or determines the MGS or MGSs which would contain a number of measurement gaps not more than a certain threshold (H3). In one specific example, the number of gaps is the smallest possible number of measurement gaps which are determined based on one or more gap related parameters. The parameters may be pre-defined or configured by a network node. Examples of such parameters are maximum number of gaps, size of MGL (e.g., minimum MGL, maximum MGL), etc. For example, the UE 702 uses the same measurement gap for maximum possible number of RA messages which can be operated using the same gap. For example, the UE 702 operates RA messages M1 and M2 which are within 9 ms in the same gap with MGL=10 ms. In another example, the UE 702 operates RA messages M1, M2 and M3, which are within 19 ms in the same gap with MGL=20 ms.
5. The above rules are described with examples shown in FIGS. 10 and 11 for 4-step RA and 2-step RA procedures:
   The example in FIG. 10 shows that, based on one or more above rules, the UE 702 selects MGS1 or MGS2 based on the proximity of different RA messages with respect to each other in 4-step RA. For example, as shown in FIG. 10(A), the UE 702 uses one gap for Msg1 and Msg2 as they are close to each other in time (e.g., Δ₂₁<H21), and also one gap for Msg3 and Msg4 as they are also close to each other in time (e.g., Δ₄₃<H21). On the other hand, as shown in FIG. 10(B), the UE uses one gap for each of Msg1, Msg2, Msg3 and Msg4 as none of them are close to each other in time (e.g., Δᵢⱼ≥H21). The set of gaps in FIG. 10(A) and FIG. 10(B) may be MGS1 and MGS2 respectively.
   The example in FIG. 11 shows that, based on one or more above rules, the UE selects MGS1 or MGS2 based on the proximity of different RA messages with regard to each other in 2-step RA. The example in FIG. 11(A) shows that the UE 702 uses one gap for MsgA-Preamble and MsgA-PUSCH as they are close to each other in time (e.g., Δ_{A1}<H22), and one gap for MsgB. But as shown in FIG. 11(B), the UE 702 uses one gap for each of MsgA-Preamble, MsgA-PUSCH, and MsgB as none of them are close to each other in time (e.g., Δᵢⱼ≥H22). In one specific example, MsgA-Preamble and MsgA-PUSCH belong to one RMG (e.g., RMG1), and MsgB belong to another RMG (e.g., RMG2). In this example, the minimum gaps in the MCG1 can therefore be two even if MsgB is close to MsgA-Preamble and MsgA-PUSCH in time. MsgA-Preamble is analogous to or equivalent to Msg1 in 4-step RA.
   In another specific example, for 4-step RACH, the gaps requested by the UE 701 (e.g., by sending message to NN1) can be for the combination of RA messages as shown in Table 3. The UE 702 can request one measurement gap (MG) in MGS1 with MGL=10 ms for Msg1 and Msg2 processing/transmission. The UE 702 can request another MG in MGS1 with MGL=20 ms for Msg3 and Msg4 processing/transmission. Optionally, the UE 702 may further request one MG in MGS1 with MGL=20 ms for Msg4 processing/transmission. The UE 702 may send the request to NN1 for different measurements gaps in MGS1 by sending one message for all gaps or in separate messages, e.g. one message per gap.

TABLE 3
An example of MGS requested by UE for 4-step RACH

| MG Index | Message Type | MGL(ms) |
|---|---|---|
| #0 | Msg1, Msg2 | 10 |
| #1 | Msg3, Msg4 | 20 |
| #2 | Msg4(Optional) | 20 |

In another specific example, for 2-step RACH, the gaps requested by the UE 702 (e.g., by sending message to NN1) can be for the combination of RA messages as shown in Table 4. The UE 702 can request one MG in MGS1 with MGL=10 ms for MsgA and MsgB processing/transmission. Optionally, the UE 702 may further request one MG in MGS2 with MGL=20 ms for MsgB processing.

TABLE 4
An example of MGS requested by UE for 2-step RACH

| MG Index | Message Type | MGL (ms) |
|---|---|---|
| #0 | MsgA, MsgB | 10 |
| #1 | MsgB (Optional) | 20 |

In another specific example, for 2-step RACH, the gaps requested by the UE 702 (e.g., by sending message to NN1) can be for the combination of RA messages as shown in Table 5. The UE 702 can request one MG in MGS1 with MGL=10 ms for MsgA (which include preamble and PUSCH messages) processing/transmission. The UE 702 may further request another MG in MGS2 with MGL=10 ms for MsgB processing.

TABLE 5
An example of MGS requested by UE for 2-step RACH

| MG Index | Message Type | MGL (ms) |
|---|---|---|
| #0 | MsgA | 10 |
| #1 | MsgB | 10 |

In another specific example, for 2-step RACH, the gaps requested by the UE 702 (e.g., by sending message to NN1) can be for the combination of RA messages as shown in Table 6. In this example it is assumed that MsgA-preamble and MsgA-PUSCH messages are separated by larger time gap, e.g. maximum time gap may be up to 30 slots. The UE 702 can request one MG in MGS1 with MGL=6 ms for operating MsgA-preamble message and another larger gap with MGL=20 ms for operating both MsgA-PUSCH and MsgB messages.

TABLE 6
An example of MGS requested by UE for 2-step RACH

| MG Index | Message Type | MGL (ms) |
|---|---|---|
| #0 | MsgA-Preamble | 6 |
| #1 | MsgA-PUSCH, MsgB | 10 |

In the above examples of the rules, the duration of each measurement gap (e.g., MGL) can be determined as follows:

The maximum number of measurement gaps (L) is less than or equal to number of RA messages (N) in a RA procedure, i.e. L≤N.

The MGL for each gap should be larger than the duration of all RA messages which can be operated in that gap. The MGL should also include RF switching times and some implementation margin. Therefore, the minimum MGL length (T_{min_gap}) containing all RA messages in the same RA group, i.e. RA messages between messages i and j, including them, can be expressed by following general function:

$${T}_{min\_g ap} = f ( Tj 2 , α2 , Ti 1 , α1 , β ) \qquad ( 4 )$$

Examples of functions f(are minimum, maximum, sum, difference, ratio, product, ceiling, floor, xth percentile, combination of two or more functions.

A specific example the function f( ) defining T_{min_gap} can be expressed as follows:

$${T}_{min\_g ap} = \{ ( Tj 2 + α 2 ) - ( Ti 1 - α1 ) + β \} \qquad ( 5 )$$

where:
   Tⱼ₂=Time instance at which or the end of the time resource in which the RA message j ends.
   Tᵢ₁=Time instance at which or the start of the time resource in which the RA message i starts
   RA message i is the first RA message of certain RMG (e.g., RMGij) in a gap.
   RA message j is the last RA message of the same RMG (e.g., RMGij) in the same gap containing RA message i.
   α1=RF switching time to switch to carrier of NW2, i.e. to operate RA messages in the gap.
   α2=RF switching time to switch to carrier of NW1, i.e. to stop operating RA messages in the gap
   In one example, α1=α2=α. In one example α=0.5 ms and 0.25 for FR1 and FR2 respectively.
   β is an implementation margin. In one example, β=0.

MGL is typically one of the discrete values, e.g. 20 ms, 10 ms, 6 ms, 5 ms, 3.5 ms, 2.5 ms, etc. Therefore, the actual measurement gap length may be larger than T_{min_gap}:

$$MGL \geq {T}_{min\_g ap} \qquad ( 6 )$$

The UE 702 is configured to use any one or more MGLs in a configured set (S_{MGL}) comprising ‘C’ number of MGLs as expressed by (7):

$${S}_{MGL} = \{ M G {L}_{1} , MG {L}_{2} , … , {MGL}_{C} \} \qquad ( 7 )$$

One specific example of the set, S_{MGL}, is expressed by (8):

$${S}_{MGL} = \{ 6 ms , 10 ms , 20 ms \} \qquad ( 8 )$$

A general example to determine MGL from T_{min_gap} can be expressed by a function in (9):

$$MGL = g ( {T}_{min\_g ap} , {MGL}_{P} , γ ) \qquad ( 9 )$$

where:
   γ is margin. In one example, γ=1.
   MGL_{P} is MGL p in the configured set, S_{MGL}, under the following constrain/condition:

$${MGL}_{P} \geq {T}_{min\_g ap} \qquad ( 10 )$$

In one specific example MGL_{P} is closest to T_{min_gap}, while meeting the condition in (10).

Examples of functions go are minimum, maximum, sum, difference, ratio, product, ceiling, floor, xth percentile, combination of two or more functions.

A specific example of the function go to determine MGL from T_{min_gap} can be expressed by (11):

$$MGL = {MGL}_{P} * CEIL ( {T}_{min\_g ap} / {MGL}_{P} ) \qquad ( 11 )$$

### 5.2 Transmission of Information about the Determined Set of Measurement to Network Node

In step 802, the UE 702 transmits information about the determined set of measurement gaps, which may be used by the UE for performing the RA procedure, to a network node, e.g. NN1. The UE 702 may further transmit the same information to other network nodes, e.g. NN2. Examples of one or more sets of information, which the UE may transmit to the network node (e.g., NN1 or NN2) are:
1. In general, the information implicitly or explicitly identifies timing of one or more gaps in the determined set of the gaps.
   a. In one example, the timing of a gap may comprise one or more of: duration of the gap (e.g., MGL), reference time when the gap starts, reference time when the gap ends, etc.
   b. In another example, the timing of a gap may comprise timing of each group of RA messages (RMG). The RA messages in the same RMG are expected to be operated by the UE 702 in the same gap. Examples of timing of RMG are duration over which all the RA messages in the RMG are expected to be operated by the UE 702 in the same gap, reference time when the RMG starts (e.g., reference time when a first RA message I in the RMG starts), reference time when the RMG starts (e.g., reference time when a last RA message j in the same RMG ends), etc.
   c. The above timing information enables the network node (e.g., NN1) to determine the time location (e.g., start timing) of each gaps in the indicated MGS (i.e., one selected by the UE 702). The timing or reference timing may be expressed in terms of one or more reference time parameters, e.g. time resource number, system frame number (SFN), slot number, subframe number etc. For example, the gap or RMG may start from an indicated slot number of a frame indicated by the SFN.
2. In another example, the UE 702 may transmit an identifier of the MGS, which has been selected by the UE 702, to the network node. This mechanism may be used when the UE 702 selects one of the pre-defined or configured MGSs also known to the network node. The UE 702 may further transmit timing related information of each gap or RMG in the selected MGS as described in the above example #1.
3. In another example, the UE 702 may transmit information about each gap in the MGS including the timing information of each gap in the MGS, which has been selected by the UE 702. This mechanism may be used when the UE selected MGS is not pre-defined.
4. In another example, the UE 702 may transmit information requesting NN2 to modify one or more parameters related to RA procedure in one or more cells in NW2. The purpose is to enable the UE 702 to select a suitable MGS, e.g. MGS1 which requires smallest number of gaps and/or number of gaps below certain threshold, or which allows the UE 702 to operate at least two RA messages in one gap etc.

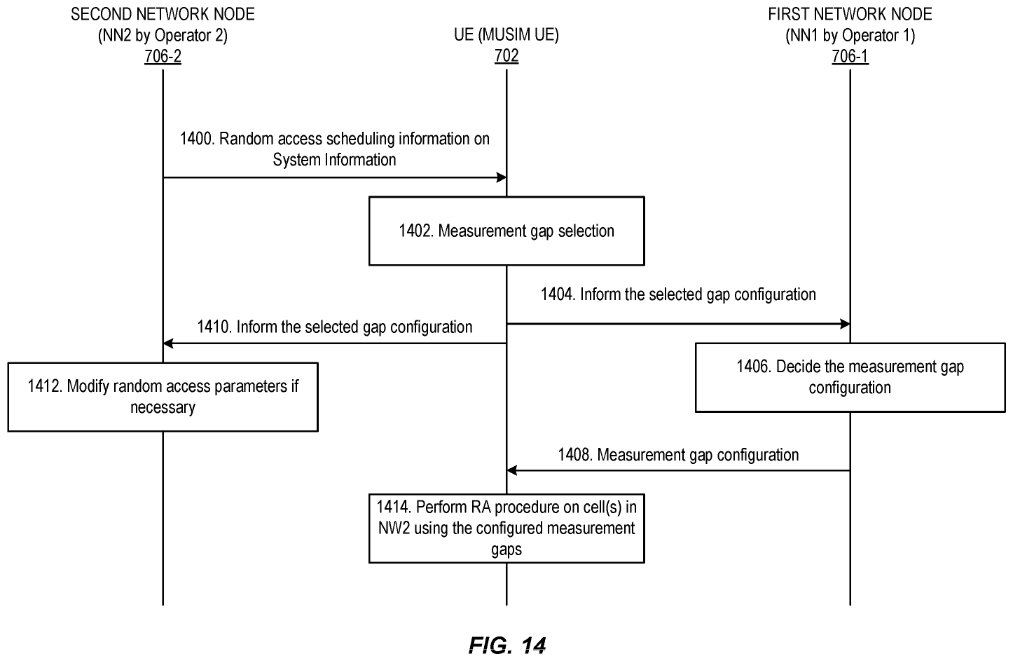

An overview of one example embodiment of the overall procedure involving the UE 702, the first network node 706-1 (i.e., NN1), and the second network node 706-2 (i.e., NN2) is shown in FIG. 14, which is described below in section 8.

### 6 Method in a First Network Node for Receiving Information about a Set of Gaps for RA Procedure and Using It for Operational Tasks

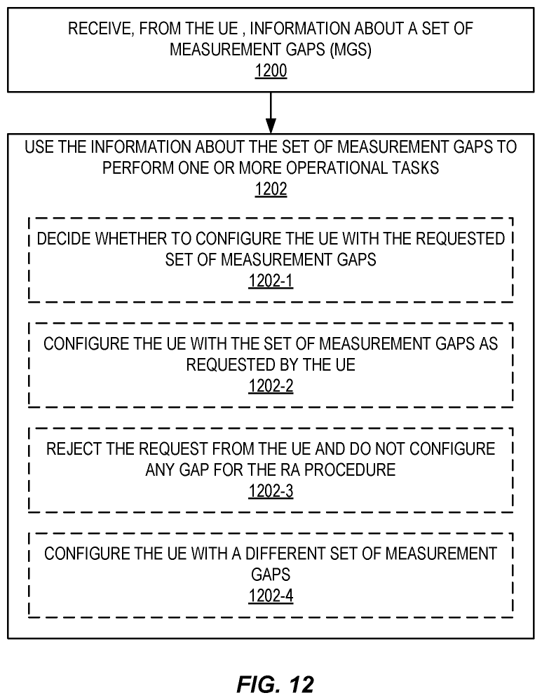

As illustrated in FIG. 12, in a second embodiment, the first network node 706-1 (i.e., NN1) receives, from the UE 702, information about a set of measurement gaps (MGS) (step 1200). The received information indicates that the UE 702 may use or is expected to use the MGS for performing a RA procedure in a cell (e.g., cell2 or cell3) comprised in NW2. This may be a request or recommendation from the UE 702.

NN1 may receive the information via one or more messages from the UE 702, e.g. via RRC, DCI, or MAC-CE. The received information is the same as transmitted by the UE 702 (which is described above in Section 5).

NN1 uses the received information for performing one or more operational tasks (step 1202). Examples of tasks are:
In one example, NN1 decides whether to configure the UE 702 with the requested set of measurement gaps or not (step 1202-1). The decision may be based on for example the UE 702 operation in NW1, e.g. whether the UE 702 is being scheduled or expected to be scheduled by NN1 in cell1. For example, if the UE buffer size is above threshold, then NN1 may configure the UE 702 with the gaps if the number of gaps in MGS is below a certain threshold. Otherwise, NN1 may not configure the gaps or may delay the configuration of the gaps.
In one example, NN1 configures the UE 702 with the set of measurement gaps as requested by the UE 702 (step 1202-2).
In another example, NN1 may reject the request from the UE 702 and does not configure any gap for the RA procedure (step 1202-3).
In another example, NN1 may configure the UE 702 with a set of measurement gaps, which is different or modified version of the requested set of measurement gaps (step 1202-4).

### 7 Method in a Second Network Node for Receiving Information about a Set of Gaps for RA Procedure and Using It for Operational Tasks

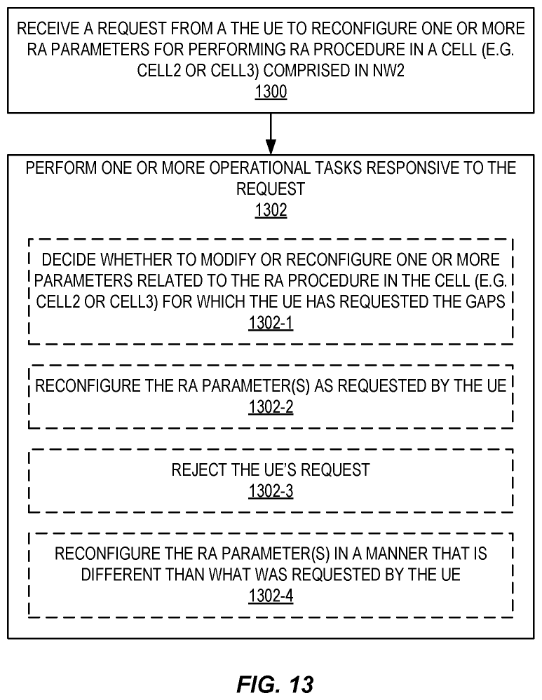

As illustrated in FIG. 13, in a third embodiment, the second network node 706-2 (i.e., NN2) receives a request from the UE 702 to reconfigure one or more RA parameters for performing RA procedure in a cell (e.g., cell2 or cell3) comprised in NW2 (step 1300). The purpose of the received request may be to enable the UE 702 to select an MGS that will contain the smallest number of gaps or which will contain a number of gaps that is below a certain threshold.

The received information may further comprise information about a set of measurement gaps (MGS) selected by the UE 702 for the current RA configuration in the cell in NW2.

NN2 may receive the information via one or more messages from the UE 702, e.g. via RRC, DCI (e.g., send in DL control channel such as PDCCH), or MAC-CE. The received information is the same as transmitted by the UE 702, which is described above section 5.

NN2 uses the received information for performing one or more operational tasks (step 1302). Examples of tasks are:
In one example, NN2 decides whether to modify or reconfigure one or more parameters related to the RA procedure in the cell (e.g., cell2 or cell3) for which the UE 702 has requested the gaps from NN1 (step 1302-1).
In one example, NN2 may reconfigure the RA parameter(s) as requested by the UE 702 (step 1302-2).
In another example, NN2 may reject the UE's request (step 1302-3).
In another example, NN2 may reconfigure the RA parameter(s), which are different or modified version of the UE requested parameters (step 1302-4).

### 8 Additional Description

FIG. 14 illustrates one example of an overall procedure performed by the UE 702, the first network node 706-1 (i.e., NN1) in the first network (NW1), and the second network node 70602 (i.e., NN2) in the second network (NW2), in accordance with at least some of the embodiments described herein (e.g., in Sections 5, 6, and 7). Note that further details regarding the steps of FIG. 14 can be found in the description above, e.g., in Sections 5, 6, and 7. As illustrated, in this example embodiment, the second network node 706-2 transmits, and the UE 702 receives, random access scheduling information on system information (i.e., as part of the system information for a respective cell) (step 1400). The UE 702 performs measurement gap selection (step 1402). In other words, the UE 702 determines, based one or more criteria or rules, a set of measurement gaps that the UE 702 may use or is expected to use for performing a RA procedure in at least one cell (e.g., cell2 or cell3) comprised in the second network (NW2), as described above with respect to step 800 of FIG. 8. The UE 702 transmits information about the determined set of measurement gaps to, in this example, the first network node 706-1 (step 1404). This information may be transmitted in accordance with any of the embodiments described above, e.g., with respected to step 802 of FIG. 8.

Responsive to receiving the information about the determined set of measurement gaps from the UE 702, the first network node 704-1, in this example embodiment, decides a measurement gap pattern to configure for the UE 702, based on the received information about the determined set of measurement gaps (step 1406). The first network node 704-1 then transmits, and the UE 702 receives, a configuration of the set of measurement gaps determined by the first network node 704-1 to be configured for the UE 702 (step 1408). As described above, this configured set of measurement gaps may be the same as or different than the set of measurement gaps determined by the UE 702.

The UE 702 may also transmit information to the second network node 706-2 that informs the second network node 706-2 of the determined set of measurement gaps (or alternatively the configured measurement gaps from step 1408) (step 1410). The second network node 706-2 may then modify one or more RA parameters for the UE 702 based on the information received in step 1410 and notify the UE 702 of the modified RA parameters (step 1412). Note that the information of step 1410 may include a set of one or more modified RA parameters recommended by or requested by the UE 702, as described above.

The UE 702 then performs a RA procedure on a cell (cell2 or cell3 in NW2) by transmitting and receiving RA related messages during the configured set of measurement gaps on cell1 in NW1 (step 1414).

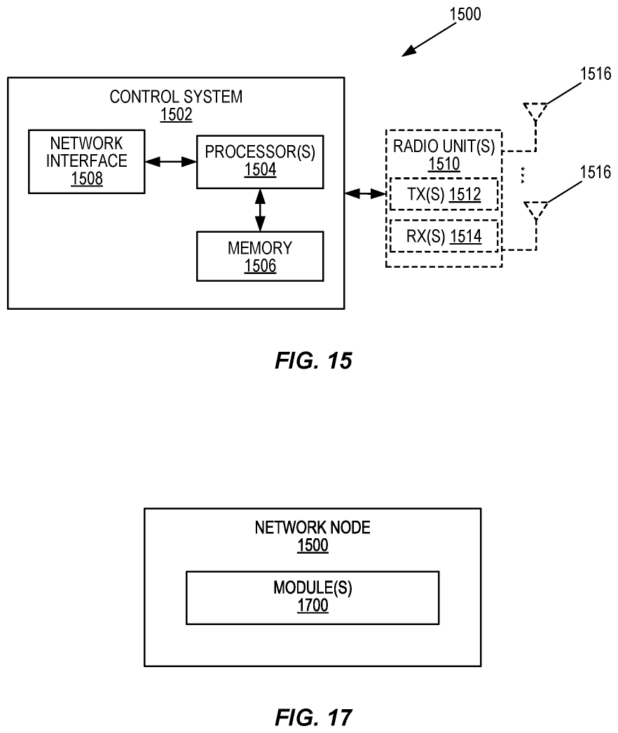

FIG. 15 is a schematic block diagram of a network node 1500 according to some embodiments of the present disclosure. Optional features are represented by dashed boxes. The network node 1500 may be, for example, the first network node 706-1 or the second network node 706-2. As illustrated, the network node 1500 includes a control system 1502 that includes one or more processors 1504 (e.g., Central Processing Units (CPUs), Application Specific Integrated Circuits (ASICs), Field Programmable Gate Arrays (FPGAs), and/or the like), memory 1506, and a network interface 1508. The one or more processors 1504 are also referred to herein as processing circuitry. In addition, the network node 1500 may include one or more radio units 1510 that each includes one or more transmitters 1512 and one or more receivers 1514 coupled to one or more antennas 1516. The radio units 1510 may be referred to or be part of radio interface circuitry. In some embodiments, the radio unit(s) 1510 is external to the control system 1502 and connected to the control system 1502 via, e.g., a wired connection (e.g., an optical cable). However, in some other embodiments, the radio unit(s) 1510 and potentially the antenna(s) 1516 are integrated together with the control system 1502. The one or more processors 1504 operate to provide one or more functions of a network node 1500 as described herein (e.g., one or more functions of the first network node 706-1 or the second network node 706-2, as described herein). In some embodiments, the function(s) are implemented in software that is stored, e.g., in the memory 1506 and executed by the one or more processors 1504.

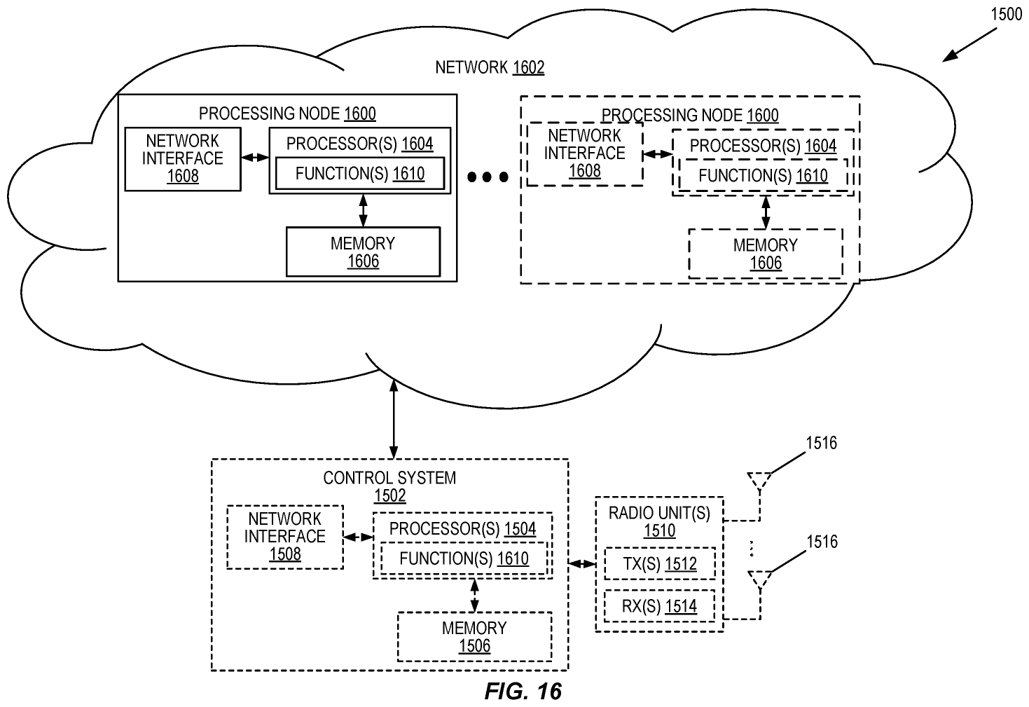

FIG. 16 is a schematic block diagram that illustrates a virtualized embodiment of the network node 1500 according to some embodiments of the present disclosure. Again, optional features are represented by dashed boxes. As used herein, a “virtualized” network node is an implementation of the network node 1500 in which at least a portion of the functionality of the network node 1500 is implemented as a virtual component(s) (e.g., via a virtual machine(s) executing on a physical processing node(s) in a network(s)). As illustrated, in this example, the network node 1500 may include the control system 1502 and/or the one or more radio units 1510, as described above. The control system 1502 may be connected to the radio unit(s) 1510 via, for example, an optical cable or the like. The network node 1500 includes one or more processing nodes 1600 coupled to or included as part of a network(s) 1602. If present, the control system 1502 or the radio unit(s) are connected to the processing node(s) 1600 via the network 1602. Each processing node 1600 includes one or more processors 1604 (e.g., CPUs, ASICs, FPGAs, and/or the like), memory 1606, and a network interface 1608.

In this example, functions 1610 of the network node 1500 described herein (e.g., one or more functions of the first network node 706-1 or the second network node 706-2, as described herein) are implemented at the one or more processing nodes 1600 or distributed across the one or more processing nodes 1600 and the control system 1502 and/or the radio unit(s) 1510 in any desired manner. In some particular embodiments, some or all of the functions 1610 of the network node 1500 described herein are implemented as virtual components executed by one or more virtual machines implemented in a virtual environment(s) hosted by the processing node(s) 1600. As will be appreciated by one of ordinary skill in the art, additional signaling or communication between the processing node(s) 1600 and the control system 1502 is used in order to carry out at least some of the desired functions 1610. Notably, in some embodiments, the control system 1502 may not be included, in which case the radio unit(s) 1510 communicate directly with the processing node(s) 1600 via an appropriate network interface(s).

In some embodiments, a computer program including instructions which, when executed by at least one processor, causes the at least one processor to carry out the functionality of network node 1500 or a node (e.g., a processing node 1600) implementing one or more of the functions 1610 of the network node 1500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the network node 1500 according to some other embodiments of the present disclosure. The network node 1500 includes one or more modules 1700, each of which is implemented in software. The module(s) 1700 provide the functionality of the network node 1500 described herein (e.g., one or more functions of the first network node 706-1 or the second network node 706-2, as described herein). This discussion is equally applicable to the processing node 1600 of FIG. 16 where the modules 1700 may be implemented at one of the processing nodes 1600 or distributed across multiple processing nodes 1600 and/or distributed across the processing node(s) 1600 and the control system 1502.

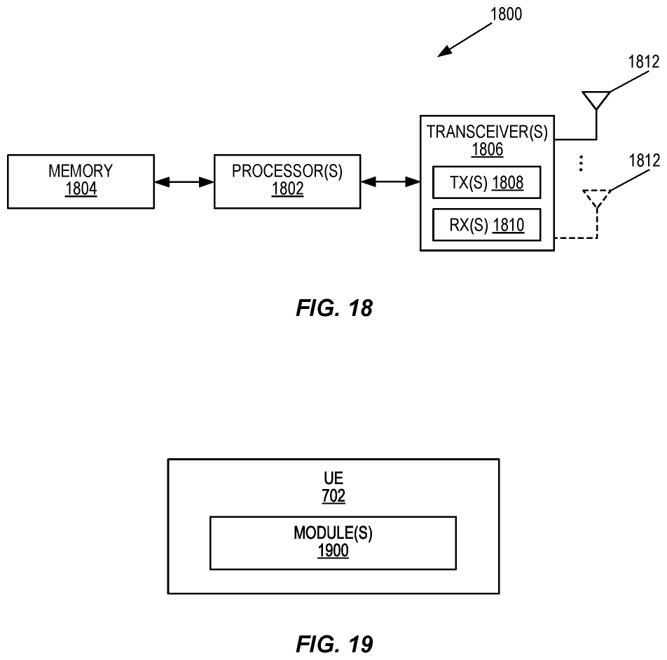

FIG. 18 is a schematic block diagram of a UE 702 according to some embodiments of the present disclosure. As illustrated, the UE 702 includes one or more processors 1802 (e.g., CPUs, ASICs, FPGAs, and/or the like), memory 1804, and one or more transceivers 1806 each including one or more transmitters 1808 and one or more receivers 1810 coupled to one or more antennas 1812. The transceiver(s) 1806 includes radio-front end circuitry connected to the antenna(s) 1812 that is configured to condition signals communicated between the antenna(s) 1812 and the processor(s) 1802, as will be appreciated by on of ordinary skill in the art. The processors 1802 are also referred to herein as processing circuitry. The transceivers 1806 are also referred to herein as radio circuitry. In some embodiments, the functionality of the UE 702 described above may be fully or partially implemented in software that is, e.g., stored in the memory 1804 and executed by the processor(s) 1802. Note that the UE 702 may include additional components not illustrated in FIG. 18 such as, e.g., one or more user interface components (e.g., an input/output interface including a display, buttons, a touch screen, a microphone, a speaker(s), and/or the like and/or any other components for allowing input of information into the UE 702 and/or allowing output of information from the UE 702), a power supply (e.g., a battery and associated power circuitry), etc.

In some embodiments, a computer program including instructions which, when executed by at least one processor, causes the at least one processor to carry out the functionality of the UE 702 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the UE 702 according to some other embodiments of the present disclosure. The UE 702 includes one or more modules 1900, each of which is implemented in software. The module(s) 1900 provide the functionality of the UE 702 described herein.

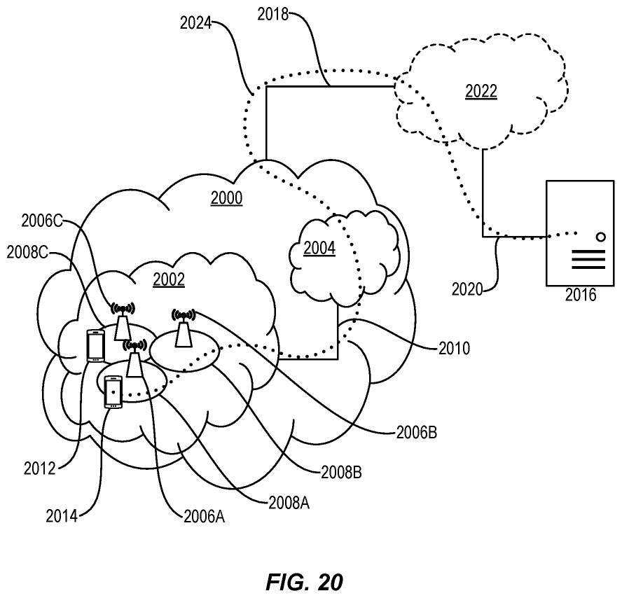

With reference to FIG. 20, in accordance with an embodiment, a communication system includes a telecommunication network 2000, such as a 3GPP-type cellular network, which comprises an access network 2002, such as a RAN, and a core network 2004. The access network 2002 comprises a plurality of base stations 2006A, 2006B, 2006C, such as Node Bs, eNBs, gNBs, or other types of wireless Access Points (APs), each defining a corresponding coverage area 2008A, 2008B, 2008C. Each base station 2006A, 2006B, 2006C is connectable to the core network 2004 over a wired or wireless connection 2010. A first UE 2012 located in coverage area 2008C is configured to wirelessly connect to, or be paged by, the corresponding base station 2006C. A second UE 2014 in coverage area 2008A is wirelessly connectable to the corresponding base station 2006A. While a plurality of UEs 2012, 2014 are illustrated in this example, the disclosed embodiments are equally applicable to a situation where a sole UE is in the coverage area or where a sole UE is connecting to the corresponding base station 2006.

The telecommunication network 2000 is itself connected to a host computer 2016, which may be embodied in the hardware and/or software of a standalone server, a cloud-implemented server, a distributed server, or as processing resources in a server farm. The host computer 2016 may be under the ownership or control of a service provider, or may be operated by the service provider or on behalf of the service provider. Connections 2018 and 2020 between the telecommunication network 2000 and the host computer 2016 may extend directly from the core network 2004 to the host computer 2016 or may go via an optional intermediate network 2022. The intermediate network 2022 may be one of, or a combination of more than one of, a public, private, or hosted network; the intermediate network 2022, if any, may be a backbone network or the Internet; in particular, the intermediate network 2022 may comprise two or more sub-networks (not shown).

The communication system of FIG. 20 as a whole enables connectivity between the connected UEs 2012, 2014 and the host computer 2016. The connectivity may be described as an Over-the-Top (OTT) connection 2024. The host computer 2016 and the connected UEs 2012, 2014 are configured to communicate data and/or signaling via the OTT connection 2024, using the access network 2002, the core network 2004, any intermediate network 2022, and possible further infrastructure (not shown) as intermediaries. The OTT connection 2024 may be transparent in the sense that the participating communication devices through which the OTT connection 2024 passes are unaware of routing of uplink and downlink communications. For example, the base station 2006 may not or need not be informed about the past routing of an incoming downlink communication with data originating from the host computer 2016 to be forwarded (e.g., handed over) to a connected UE 2012. Similarly, the base station 2006 need not be aware of the future routing of an outgoing uplink communication originating from the UE 2012 towards the host computer 2016.

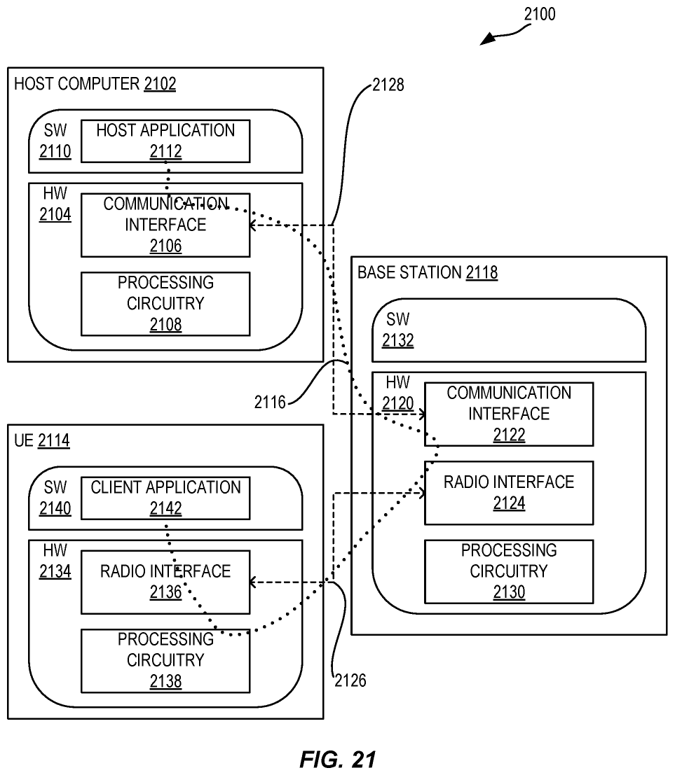

Example implementations, in accordance with an embodiment, of the UE, base station, and host computer discussed in the preceding paragraphs will now be described with reference to FIG. 21. In a communication system 2100, a host computer 2102 comprises hardware 2104 including a communication interface 2106 configured to set up and maintain a wired or wireless connection with an interface of a different communication device of the communication system 2100. The host computer 2102 further comprises processing circuitry 2108, which may have storage and/or processing capabilities. In particular, the processing circuitry 2108 may comprise one or more programmable processors, ASICs, FPGAs, or combinations of these (not shown) adapted to execute instructions. The host computer 2102 further comprises software 2110, which is stored in or accessible by the host computer 2102 and executable by the processing circuitry 2108. The software 2110 includes a host application 2112. The host application 2112 may be operable to provide a service to a remote user, such as a UE 2114 connecting via an OTT connection 2116 terminating at the UE 2114 and the host computer 2102. In providing the service to the remote user, the host application 2112 may provide user data which is transmitted using the OTT connection 2116.

The communication system 2100 further includes a base station 2118 provided in a telecommunication system and comprising hardware 2120 enabling it to communicate with the host computer 2102 and with the UE 2114. The hardware 2120 may include a communication interface 2122 for setting up and maintaining a wired or wireless connection with an interface of a different communication device of the communication system 2100, as well as a radio interface 2124 for setting up and maintaining at least a wireless connection 2126 with the UE 2114 located in a coverage area (not shown in FIG. 21) served by the base station 2118. The communication interface 2122 may be configured to facilitate a connection 2128 to the host computer 2102. The connection 2128 may be direct or it may pass through a core network (not shown in FIG. 21) of the telecommunication system and/or through one or more intermediate networks outside the telecommunication system. In the embodiment shown, the hardware 2120 of the base station 2118 further includes processing circuitry 2130, which may comprise one or more programmable processors, ASICs, FPGAs, or combinations of these (not shown) adapted to execute instructions. The base station 2118 further has software 2132 stored internally or accessible via an external connection.

The communication system 2100 further includes the UE 2114 already referred to. The UE's 2114 hardware 2134 may include a radio interface 2136 configured to set up and maintain a wireless connection 2126 with a base station serving a coverage area in which the UE 2114 is currently located. The hardware 2134 of the UE 2114 further includes processing circuitry 2138, which may comprise one or more programmable processors, ASICs, FPGAs, or combinations of these (not shown) adapted to execute instructions. The UE 2114 further comprises software 2140, which is stored in or accessible by the UE 2114 and executable by the processing circuitry 2138. The software 2140 includes a client application 2142. The client application 2142 may be operable to provide a service to a human or non-human user via the UE 2114, with the support of the host computer 2102. In the host computer 2102, the executing host application 2112 may communicate with the executing client application 2142 via the OTT connection 2116 terminating at the UE 2114 and the host computer 2102. In providing the service to the user, the client application 2142 may receive request data from the host application 2112 and provide user data in response to the request data. The OTT connection 2116 may transfer both the request data and the user data. The client application 2142 may interact with the user to generate the user data that it provides.

It is noted that the host computer 2102, the base station 2118, and the UE 2114 illustrated in FIG. 21 may be similar or identical to the host computer 2016, one of the base stations 2006A, 2006B, 2006C, and one of the UEs 2012, 2014 of FIG. 20, respectively. This is to say, the inner workings of these entities may be as shown in FIG. 21 and independently, the surrounding network topology may be that of FIG. 20.

In FIG. 21, the OTT connection 2116 has been drawn abstractly to illustrate the communication between the host computer 2102 and the UE 2114 via the base station 2118 without explicit reference to any intermediary devices and the precise routing of messages via these devices. The network infrastructure may determine the routing, which may be configured to hide from the UE 2114 or from the service provider operating the host computer 2102, or both. While the OTT connection 2116 is active, the network infrastructure may further take decisions by which it dynamically changes the routing (e.g., on the basis of load balancing consideration or reconfiguration of the network).

The wireless connection 2126 between the UE 2114 and the base station 2118 is in accordance with the teachings of the embodiments described throughout this disclosure. One or more of the various embodiments improve the performance of OTT services provided to the UE 2114 using the OTT connection 2116, in which the wireless connection 2126 forms the last segment.

A measurement procedure may be provided for the purpose of monitoring data rate, latency, and other factors on which the one or more embodiments improve. There may further be an optional network functionality for reconfiguring the OTT connection 2116 between the host computer 2102 and the UE 2114, in response to variations in the measurement results. The measurement procedure and/or the network functionality for reconfiguring the OTT connection 2116 may be implemented in the software 2110 and the hardware 2104 of the host computer 2102 or in the software 2140 and the hardware 2134 of the UE 2114, or both. In some embodiments, sensors (not shown) may be deployed in or in association with communication devices through which the OTT connection 2116 passes; the sensors may participate in the measurement procedure by supplying values of the monitored quantities exemplified above, or supplying values of other physical quantities from which the software 2110, 2140 may compute or estimate the monitored quantities. The reconfiguring of the OTT connection 2116 may include message format, retransmission settings, preferred routing, etc.; the reconfiguring need not affect the base station 2118, and it may be unknown or imperceptible to the base station 2118. Such procedures and functionalities may be known and practiced in the art. In certain embodiments, measurements may involve proprietary UE signaling facilitating the host computer's 2102 measurements of throughput, propagation times, latency, and the like. The measurements may be implemented in that the software 2110 and 2140 causes messages to be transmitted, in particular empty or ‘dummy’ messages, using the OTT connection 2116 while it monitors propagation times, errors, etc.

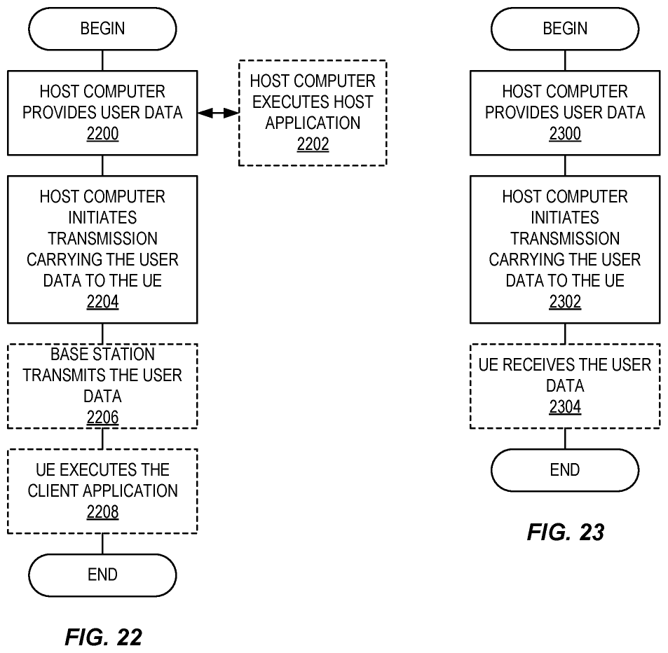

FIG. 22 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 22 will be included in this section. In step 2200, the host computer provides user data. In sub-step 2202 (which may be optional) of step 2200, the host computer provides the user data by executing a host application. In step 2204, the host computer initiates a transmission carrying the user data to the UE. In step 2206 (which may be optional), the base station transmits to the UE the user data which was carried in the transmission that the host computer initiated, in accordance with the teachings of the embodiments described throughout this disclosure. In step 2208 (which may also be optional), the UE executes a client application associated with the host application executed by the host computer.

FIG. 23 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 23 will be included in this section. In step 2300 of the method, the host computer provides user data. In an optional sub-step (not shown) the host computer provides the user data by executing a host application. In step 2302, the host computer initiates a transmission carrying the user data to the UE. The transmission may pass via the base station, in accordance with the teachings of the embodiments described throughout this disclosure. In step 2304 (which may be optional), the UE receives the user data carried in the transmission.

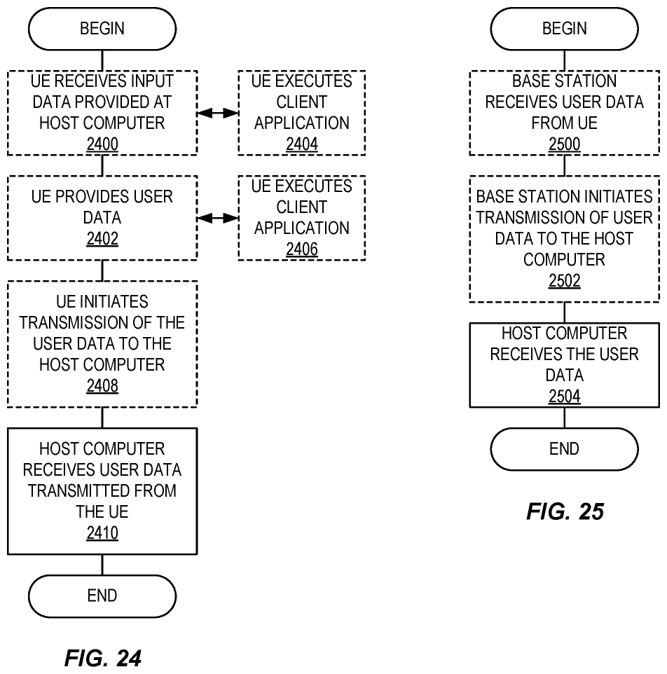

FIG. 24 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 24 will be included in this section. In step 2400 (which may be optional), the UE receives input data provided by the host computer. Additionally or alternatively, in step 2402, the UE provides user data. In sub-step 2404 (which may be optional) of step 2400, the UE provides the user data by executing a client application. In sub-step 2406 (which may be optional) of step 2402, the UE executes a client application which provides the user data in reaction to the received input data provided by the host computer. In providing the user data, the executed client application may further consider user input received from the user. Regardless of the specific manner in which the user data was provided, the UE initiates, in sub-step 2408 (which may be optional), transmission of the user data to the host computer. In step 2410 of the method, the host computer receives the user data transmitted from the UE, in accordance with the teachings of the embodiments described throughout this disclosure.

FIG. 25 is a flowchart illustrating a method implemented in a communication system, in accordance with one embodiment. The communication system includes a host computer, a base station, and a UE which may be those described with reference to FIGS. 20 and 21. For simplicity of the present disclosure, only drawing references to FIG. 25 will be included in this section. In step 2500 (which may be optional), in accordance with the teachings of the embodiments described throughout this disclosure, the base station receives user data from the UE. In step 2502 (which may be optional), the base station initiates transmission of the received user data to the host computer. In step 2504 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. (canceled)

2. (canceled)

3. A method performed by a User Equipment, comprising:
determining, for a first cell of a first network, a first set of measurement gaps that the UE may use or is expected to use to perform a random access procedure in at least one second cell of a second network; and
transmitting information about the first set of measurement gaps to one or more network nodes.

4. The method of claim 3 wherein the UE is served by at least two cells comprising the first cell of the first network and the at least one second cell of the second network, the at least two cells operate on or belong to or are configured using respective carrier frequencies, and the UE is served by the at least two cells during respective time periods that at least partially overlap.

5. The method of claim 3 wherein transmitting the information about the first set of measurement gaps to the one or more network nodes comprises transmitting the information about the first set of measurement gaps to a first network node that manages or serves or controls the first cell of the first network.

6. The method of claim 5 further comprising receiving one or more messages from the first network node in response to transmitting the information about the first set of measurement gaps to the first network node.

7-9. (canceled)

10. The method of claim 3 wherein determining the first set of measurement gaps that the UE may use or is expected to use to perform the RA procedure in at least one second cell of the second network comprises determining the first set of measurement gaps based on one or more rules or criteria.

11. The method of claim 3 wherein determining the first set of measurement gaps that the UE may use or is expected to use to perform the RA procedure in at least one second cell of the second network comprises selecting the first set of measurement gaps from among two or more predefined, configured, or autonomously determined sets of measurement gaps, based on one or more rules or criteria.

12. The method of claim 11 wherein the two or more predefined, configured, or autonomously determined sets of measurement gaps have different numbers of measurement gaps.

13. The method of claim 12 wherein the two or more predefined, configured, or autonomously determined sets of measurement gaps are different in terms of a measurement gap length of at least one measurement gap in each of the two or more predefined, configured, or autonomously determined sets of measurement gaps.

14. The method of claim 10 wherein one or more rules or criteria comprise one or more rules or criteria related to timing one or more RA messages within the RA procedure.

15. The method of claim 10 wherein one or more rules or criteria comprise one or more rules or criteria related a total duration of the RA procedure, a type of the RA procedure, maximum number of gaps, timing relation between RA messages within the RA procedure as compared to measurement gap length, or any combination thereof.

16. The method of claim 3 further comprising transmitting, to a second network node that controls or manages or serves a second cell of the second network, a request to reconfigure one or more RA related parameters.

17. The method of claim 16 wherein the request comprises one or more recommended or requested values for one or more RA related parameters that are based on either the first set of measurement gaps determined by the UE or a configured set of measurement gaps configured for the UE responsive to transmitting the information about the first set of measurement gaps to the first network node that manages or serves or controls the first cell of the first network.

18. (canceled)

19. (canceled)

20. A User Equipment comprising:
one or more transmitters;
one or more receivers; and
processing circuitry associated with the one or more transmitters and the one or more receivers, the processing circuitry configured to cause the UE to:
determine, for a first cell of a first network, a first set of measurement gaps that the UE may use or is expected to use to perform a random access procedure in at least one second cell of a second network; and
transmit information about the first set of measurement gaps to one or more network nodes.

21. (canceled)

22. A method performed by a first network node that manages or controls or serves a first cell of a first network, the method comprising:
receiving, from a User Equipment, information about a first set of measurement gaps for the UE for the first cell of the first network, the first set of measurement gaps being a set of measurement gaps that the UE may use or is expected to use to perform a random access procedure in at least one second cell of a second network; and
performing one or more operational tasks based on the information about the first set of measurement gaps.

23. The method of claim 22 wherein performing the one or more operational tasks based on the information about the first set of measurement gaps comprises deciding whether to configure the UE with the first set of measurement gaps.

24. The method of claim 22 wherein performing the one or more operational tasks based on the information about the first set of measurement gaps comprises configuring the UE with the first set of measurement gaps.

25. The method of claim 22 wherein performing the one or more operational tasks based on the information about the first set of measurement gaps comprises configuring the UE with a second set of measurement gaps that is different than the first set of measurement gaps.

26. The method of claim 22 wherein performing the one or more operational tasks based on the information about the first set of measurement gaps comprises transmitting, to the UE, a message that indicates that the UE cannot be configured with the first set of measurement gaps.

27. The method of claim 22 wherein performing the one or more operational tasks based on the information about the first set of measurement gaps comprises transmitting, to the UE, a message that indicates that the UE cannot be configured with a set of measurement gaps for performing the RA procedure in the at least one second cell of the second network.

28-29. (canceled)

30. A first network node for managing or controlling or serving a first cell of a first network, the first network node comprising processing circuitry configured to cause the first network node to:
receive, from a User Equipment, information about a first set of measurement gaps for the UE for the first cell of the first network, the first set of measurement gaps being a set of measurement gaps that the UE may use or is expected to use to perform a random access, RA, procedure in at least one second cell of a second network; and
perform one or more operational tasks based on the information about the first set of measurement gaps.

31-42. (canceled)
